(19) United States
(12) Patent Application Publication
(10) Pub. No.: US 2021/0288506 A1
(43) Pub. Date: Sep. 16, 2021

(54) Power system of electric vehicle

(71) Applicant: Shouichi TANAKA, Nagoya-shi, Aichi (JP)

(72) Inventor: Shouichi TANAKA, Nagoya-shi, Aichi (JP)

(21) Appl. No.: 16/973,478

(22) PCT Filed: Jun. 7, 2019
(86) PCT No.: PCT/JP2019/022803

§ 371 Date: Dec. 9, 2020

(30) Foreign Application Priority Data
Jun. 18, 2018 (JP) PCT/JP2018/023139
Nov. 9, 2018 (JP) 2018-211287

(51) Int. Cl. H02J 7/00; H02M 3/158; H02P 27/08; H02M 1/00; B60L 53/22

(52) U.S. Cl. CPC H02J 7/007; H02M 3/158; H02P 27/08; B60L 2210/14; H02J 7/0016; B60L 53/22; H02J 2207/20; H02M 1/0054

(57) ABSTRACT

A dual inverter is connected to a double-ended three-phase coil of a three-phase motor. The dual inverter is operated as a rectifier for rectifying a grid voltage. The dual inverter is connected to a DC power supply including a bi-directional DCDC converter for changing a power-supply voltage. Each of three H-bridges of the dual inverter consists of a PWM-leg and a fixed potential leg, which are regularly changed. An upper arm switch is continuously turned on. A cold battery supplies a single-phase AC current to the three-phase motor in order to produce an alternating magnetic field.

### TECHNICAL FIELD

The present invention relates to a power system of an electric vehicle defined as a vehicle with an electric traction motor.

### PRIOR ARTS

Patent literature 1 proposes to construct an on-board charger consisting of two star-shaped three-phase coils and two three-phase inverters. A single-phase grid voltage is applied to neutral points of the two three-phase coils. However, the on-board charger needs a complicated switch system for opening each of the neutral points. Patent literature 1 further proposes another on-board charger consisting of three star-shaped three-phase coils and three three-phase inverters. A three-phase grid voltage is applied to three neutral points. However, each phase current with same phase flows through three phase coils of each star-shaped three-phase coils. Thus, each phase magnetic field magnetized by three phase coils is canceled each other. Therefore, each star-shaped three-phase coil has a low inductance value.

Patent literature 2 proposes one driving method of a dual inverter consisting of two three-phase inverters connected to a double-ended three-phase coil. This driving method for driving the two three-phase inverters with PWM method is called the double PWM method. The dual inverter has a double PWM mode and a pulse mode. In the double PWM mode, the two three-phase inverters output three-phase sinusoidal voltages waveforms of which are opposite each other. In the pulse mode, the two three-phase inverters output rectangular voltages waveforms of which are opposite each other. The dual inverter essentially consists of three H-bridges. Two legs of each H-bridge become PWM-legs in the double PWM mode, and become fixed potential legs in the pulse mode. The PWM-leg means a leg controlled by PWM method, and the fixed potential leg means a leg which outputs a DC voltage.

Patent literature 3 proposes a DC power supply of voltage-changing type, which consists of switched batteries with reactors. The DC power supply has a parallel mode, a series mode, and a voltage-boosting mode. However, the switched batteries with reactors needs two reactors which always generate power losses.

### CITED REFERENCE

### Patent Literature

(Patent literature 1) Japan unexamined patent publication No. 2013-243868

(Patent literature 2) Japan unexamined patent publication No. 2006-149145

(Patent literature 3) Japan patent No. 5492040

### SUMMARY OF INVENTION

An object of the present invention is to provide a power system with relatively low cost in comparison with its performance.

A first aspect of the present invention, at least one part of an on-board charger consists of a dual inverter, which connects a double-ended three-phase coil of a motor to a DC power supply. A grid voltage applied to either of two three-phase inverters of the dual inverter is rectified by either one of the two three-phase inverters.

In one embodiment, the grid voltage is applied to one of the two three-phase inverters, the other three-phase inverter becomes a voltage-boosting chopper for boosting the grid voltage.

In another embodiment, the DC power supply has a bi-directional DCDC converter for boosting a battery voltage. A grid voltage rectified by one of the two three-phase inverters is stepped down by the bi-directional DCDC converter.

In another embodiment, the voltage-changing DC power supply disclosed by a second aspect is employed. A power-supply voltage of the DC power supply is changed in accordance with a peak value of the grid voltage applied to the dual inverter.

In another embodiment, the dual inverter is driven by single PWM method. Thus, power losses of the inverter is reduced. Suitably, the dual inverter is driven by the single PWM of upper-arm-conduction type. Thus, a ringing surge voltage is reduced.

According to the second aspect of the present invention, the power system employs a DC power supply of voltage-changing type, which consists of a switched battery device with a reactor. The switched battery device with a reactor has a connection-changing circuit for changing connection of the two batteries. The connection-changing circuit consists of a bi-directional DCDC converter, which has a series transistor, two parallel transistors, a reactor, an outputting transistor, and a discharging diode. The reactor connects the series transistor and one of the two parallel transistors. The discharging diode, which is connected to a connection point, which connects the reactor and the series transistor, discharges the reactor. Therefore, battery losses and inverter losses are reduced. Preferably, the voltage-changing type DC power supply has a parallel mode, a series mode, a voltage-boosting mode, and a voltage-dropping mode. Furthermore, the voltage-changing type DC power supply has a transient mode.

In one embodiment, a controller has a voltage-equalization mode for selectively charging the battery which has lower voltage. In another embodiment, the controller has a voltage-equalization mode for selectively discharging the battery which has higher voltage. The voltage-equalization mode are executed before connecting two batteries in parallel. The voltage-equalization mode are executed before connecting two batteries in para is capable to be employed by a conventional voltage-changing type DC power supply. In another embodiment, the parallel mode which use only the normal battery when one of the two battery of the DC power supply is bad. Thus, reliability of the DC power supply is improved.

In another embodiment, the DC power supply charges a low-voltage battery through a sub DCDC converter. The two batteries of the DC power supply respectively supply primary currents to two primary coils of a step-down transformer. Thus, the low-voltage battery is charged stably in spite of voltage-changing of the DC power supply. The sub DCDC converter is capable to be employed by a conventional voltage-changing type DC power supply.

According to the third aspect of the present invention, the dual inverter connected to the double-ended three-phase coil is driven by the single PWM method. Each of three H-bridges of the dual inverter consists of a PWM-leg and a fixed potential leg. The PWM-leg and the fixed potential leg are changed every predetermined period. Thus, the inverter loss is reduced, and temperature differences among elements of the dual inverter are reduced.

In one embodiment, an upper arm switch of the fixed potential leg is always turned on, and a lower arm switch of the PWM-leg is controlled by PWM method. This method is called the upper-arm-conduction type single PWM. Thus, a ringing surge voltage is reduced. Therefore, switching losses of the inverter are reduced.

In another embodiment, the three H-bridges are controlled by space-vector-PWM (SVPWM) method. Current-supplying periods of the three H-bridges are arranged in each common PWM cycle period so as not to overlap as much as possible. Accordingly, battery loss is reduced.

In another embodiment, the current-supplying periods of three phases are arranged continuously. Thus, power loss of a smoothing capacitor is reduced.

In another embodiment, the dual inverter is driven by the double H-bridge mode which stops one of the three H-bridges in turn. Thus, power loss of the inverter is reduced.

In another embodiment, the dual inverter executes new battery-heating method when a battery temperature is low. The dual inverter supplies a single-phase AC current to only one phase coil or two phase coils of the double-ended three-phase coil. The single-phase AC current does not produce a rotating magnetic field in the motor. It is capable to employ one three-phase inverter connected to a star-shaped three-phase coil instead of the dual inverter connected to the double-ended three-phase coil. In other words, this battery-heating method is capable to be employed by a conventional three-phase motor-driving device.

### BRIEF DESCRIPTION OF DRAWINGS

FIG. 1 is a wiring diagram for showing a three-phase on-board charger of a first embodiment.

FIG. 2 is a wiring diagram for showing a single-phase on-board charger of a first embodiment.

FIG. 3 is a wiring diagram for showing an on-board charger of voltage-changing type.

FIG. 4 is a configuration for showing voltage-changing operation of a DC power supply of voltage-changing type.

FIG. 5 is a schematic wiring diagram for showing a voltage-boosting mode of the DC power supply shown in FIG. 4.

FIG. 6 is a schematic wiring diagram for showing a voltage-boosting mode of the DC power supply shown in FIG. 4.

FIG. 7 is a schematic wiring diagram for showing an accumulating mode of a transient mode.

FIG. 8 is a schematic wiring diagram for showing a demagnetizing mode of the transient mode.

FIG. 9 is a schematic wiring diagram for showing a voltage-dropping mode of the DC power supply shown in FIG. 10.

FIG. 10 is a schematic wiring diagram for showing a voltage-dropping mode of the DC power supply shown in FIG. 10.

FIG. 11 is a wiring diagram for showing a sub charging system of a second embodiment.

FIG. 12 is a waveform configuration for showing waveforms of a single-phase voltage an a single-phase current, which are used in a third embodiment.

FIG. 13 is a timing chart for showing a battery-heating mode of the third embodiment.

FIG. 14 is a schematic wiring diagram for showing a dual inverter of a fourth embodiment.

FIG. 15 is a waveform configuration for showing a U-phase current and a fundamental wave component of a U-phase voltage.

FIG. 16 is a timing chart for for showing states of one H-bridge in a positive half-wave period of a PWM cycle period.

FIG. 17 is a timing chart for for showing states of one H-bridge in a negative half-wave period of a PWM cycle period.

FIG. 18 is a timing chart for showing a triple-H-bridge mode of the dual inverter.

FIG. 19 is a waveform configuration for showing fundamental wave components of outputting voltages of one H-bridge.

FIG. 20 is a vector configuration for showing a synthetic voltage vector of the dual inverter.

FIG. 21 is a timing chart for showing a double-H-bridge mode of the dual inverter.

FIG. 22 is a timing chart for showing current-dispersion method of the dual inverter.

FIG. 23 is a block circuit diagram for showing a power system which employs the current--dispersion method.

FIG. 24 is a timing chart for showing the current-dispersion method in the triple-H-bridge mode.

FIG. 25 is a timing chart for showing the the current-dispersion method in the double-H-bridge mode.

FIG. 26 is a schematic wiring diagram for explaining surge voltages induced when an upper arm switch of an H-bridge is turning-off.

FIG. 28 is an equivalent circuit diagram for showing a conventional three-phase inverter as a reference example.

FIG. 29 is an equivalent circuit diagram for showing the dual inverter which employs the single-PWM method.

FIG. 30 is a timing chart for showing each phase voltage which is outputted by the dual inverter of a prior double PWM method.

### PREFERRED EMBODIMENTS

### A First Embodiment

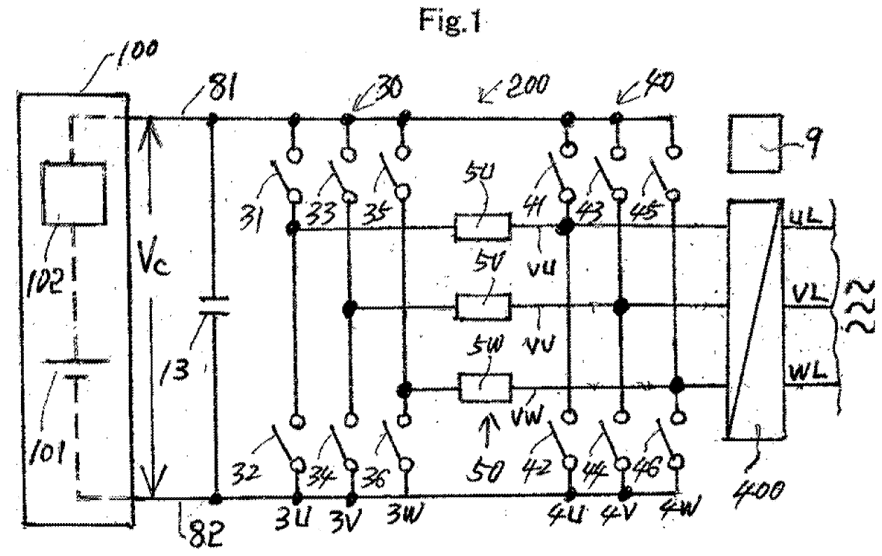

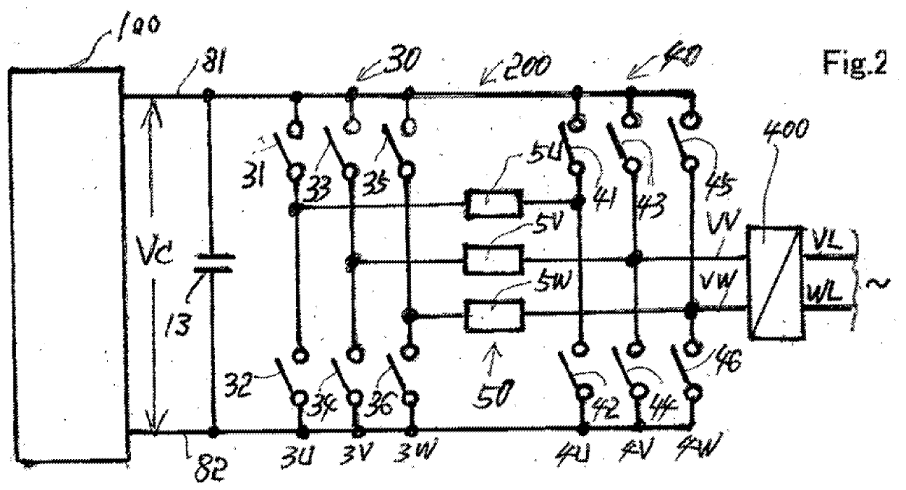

A power system of an electric vehicle, which is used as an on-board charger, is explained referring to FIG. 1 and FIG. 2. The power system includes of a DC power supply 100, a dual inverter 200, an open-ended three-phase coil 50, a controller 9, and a connector 400. The three-phase coil 50 consists of a stator coil of a traction motor.

The DC power supply 100, which has a battery 101 and a bi-directional DCDC converter 102, applies a power-supply voltage Vc to the dual inverter 200 through a positive power-supply line 81 and a negative power-supply line 82 connected by a smoothing capacitor 13. The dual inverter 200 consists of two three-phase inverters 30 and 40, which are controlled by the controller 9.

The inverter 30 consists of a U-phase leg 3U, a V-phase leg 3V, and a W-phase leg 3W, each of which consists of an upper arm switch and a lower arm switch connected to series each other. The leg 3U has the upper arm switch 31 and the lower arm switch 32. The leg 3V has the upper arm switch 33 and the lower arm switch 34. The leg 3W has the upper arm switch 35 and the lower arm switch 36. Similarly, the inverter 40 consists of a U-phase leg 4U, a V-phase leg 4V, and a W-phase leg 4W, each of which consists of an upper arm switch and a lower arm switch connected to series each other.

The leg 4U has the upper arm switch 41 and the lower arm switch 42. The leg 4V has the upper arm switch 43 and the lower arm switch 44. The leg 4W has the upper arm switch 45 and the lower arm switch 46. Each switch consists of an IGBT and an anti-parallel diode.

The three-phase coil 50 consists of a U-phase coil 5U, a V-phase coil 5V, and a W-phase coil 5W both ends of which are opened. One end of phase coil 5U is connected to leg 3U, and the other end is connected to leg 4U. One end of phase coil 5V is connected to leg 3V, and the other end is connected to leg 4V. One end of phase coil 5W is connected to leg 3W, and the other end is connected to leg 4W.

FIG. 1 shows the on-board charger connected to a three-phase grid. In FIG. 1, three outputting terminals of inverter 40 are connected to the three-phase grid through the connector 400. The three-phase grid applies a three-phase grid voltage (VU, VV, and VW) through cables (UL, VL, and WL). connector 400 applies the three-phase grid voltage (VU, VV, and VW) to the three outputting terminals of inverter 40.

FIG. 2 shows the on-board charger connected to a single-phase grid. In FIG. 2, two outputting terminals of inverter 40 are connected to the single-phase grid through the connector 400. The single-phase grid applies a single-phase grid voltage (VV and VW) through cables (VL and WL). connector 400 applies the single-phase grid voltage to the two outputting terminals of inverter 40.

A charging mode of the on-board charger is explained. The charging mode includes a voltage-boosting charging mode and a voltage-dropping charging mode. The voltage-boosting charging mode is employed under the condition that a voltage of battery 101 is higher than a peak value of the grid voltage. The voltage-dropping charging mode is employed under the condition that the voltage of battery 101 is lower than the peak value of the grid voltage.

In the voltage-boosting charging mode, three-phase inverter 30 and three-phase coil 50 are driven as a step-up chopper. In the voltage-dropping charging mode, three-phase inverter 40 is driven as a rectifier. The rectified voltage charges battery 101 of DC power supply 100 after stepping down by the converter 102 of DC power supply 100.

The charging mode includes a three-phase middle-voltage mode, a three-phase high-voltage mode, and a single-phase mode. A rated voltage of battery 101 is 360V. The three-phase middle-voltage mode uses a three-phase grid voltage with 200V to 250V. The three-phase high-voltage mode uses a three-phase grid voltage with 400V to 480V. The single-phase mode uses a single-phase grid voltage a peak voltage of which is less than 250V.

### The Three-phase Middle-voltage Mode

The three-phase middle-voltage mode which employs the voltage-boosting charging mode is explained. A peak value of the three-phase grid voltage is 354V. Inverter 40 is stopped. Inverter 30 and three-phase coil 50 produces three of stepping-up choppers. Phase coil 5U and leg 3U produces a U-phase stepping-up chopper Phase coil 5V and leg 3V produces a V-phase stepping-up chopper Phase coil 5W and leg 3W produces a W-phase stepping-up chopper

Operation of the U-phase stepping-up chopper is explained. Lower arm switch 32 is controlled by PWM method in a period while U-phase voltage VU is higher than V-phase voltage VV and W-phase voltage VW. An accumulation current flows through phase coil 5U, switch 32, lower switches of inverter 40 from cable UL when switch 32 is turned on. Phase coil 5U accumulates magnetic energy. A charging current flows through phase coil 5U, upper arm switch 31, DC power supply 100, and lower switches of inverter 40 from cable UL when switch 32 is turned off. Thus, battery 101 is charged.

The charging current is adjusted by controlling of switch 32 by means of PWM method. Bidirectional DCDC converter 102 of DC power supply 100 is stopped. Each of the V-phase stepping-up chopper and the W-phase stepping-up chopper has essentially same operation as the U-phase stepping-up chopper. After all, these three stepping-up choppers execute the voltage-boosting operation in turn every 120 electrical degrees. Only the stepping-up chopper which has the lowest stepping-up ratio executes the voltage-boosting operation.

In a charging period in which the voltage-boosting charging mode is executed, a current which flows through three-phase coil 50 produces rotating magnetic field in the traction motor. The rotating magnetic field has an angular speed which synchronizes with the grid voltage. However, a synchronous motor with three-phase coil 50 is stopped in the charging period. Accordingly, average torque of the synchronous motor becomes zero. An induction motor with three-phase coil 50 uses only the U-phase stepping-up chopper. Thus, starting torque of the induction motor becomes zero.

### The Three-phase High-voltage Mode

The three-phase high-voltage mode which employs the voltage-dropping charging mode is explained. A peak value of the three-phase grid voltage is 676V. Inverter 30 is stopped. Inverter 40, which is driven as a three-phase rectifier, applies a rectified voltage to converter 102. Converter 102 steps down the rectified voltage and charges battery 101.

### The Single-phase Mode

The single-phase mode which employs the voltage-boosting charging mode is explained referring to FIG. 2. A peak value of the single-phase grid voltage is 177V or 354V. Inverter 40 is stopped. Leg 3V and phase coil 5V produces the V-phase stepping-up chopper Leg 3W and phase coil 5W produces the W-phase stepping-up chopper, The V-phase stepping-up chopper applies the voltage-boosting voltage to battery 101 when V-phase voltage W is higher than W-phase voltage VW. The W-phase stepping-up chopper applies the voltage-boosting voltage to battery 101 when V-phase voltage W is lower than W-phase voltage VW. Consequently, the single-phase stepping-up chopper, which consists of inverter 30 and three-phase coil 50, charges battery 101 by using the single-phase grid voltage.

Next, the three-phase discharging mode, which supplies AC electric power from DC power supply 100 to the three-phase grid, is explained. In FIG. 1, DC power supply 100 applies power-supply voltage Vc, which is higher than a peak value of the grid voltage, to inverter 40. Inverter 30 is stopped. Three legs (4U, 4V, and 4W) of inverter 40 controlled by PWM method supplies AC power to the grid. Next, the single-phase discharging mode, which supplies AC electric power from DC power supply 100 to the single-phase grid, is explained. In FIG. 2, DC power supply 100 applies power-supply voltage Vc, which is higher than a peak value of the grid voltage, to inverter 40. Inverter 30 is stopped. Two legs (4V and 4W) of inverter 40 controlled by PWM method supplies AC power to the grid.

### The Second Embodiment

Power losses of the on-board charger of the first embodiment increases when difference between the grid voltage and the battery voltage. This problem is improved by changing power-supply voltage Vc of DC power supply 100.

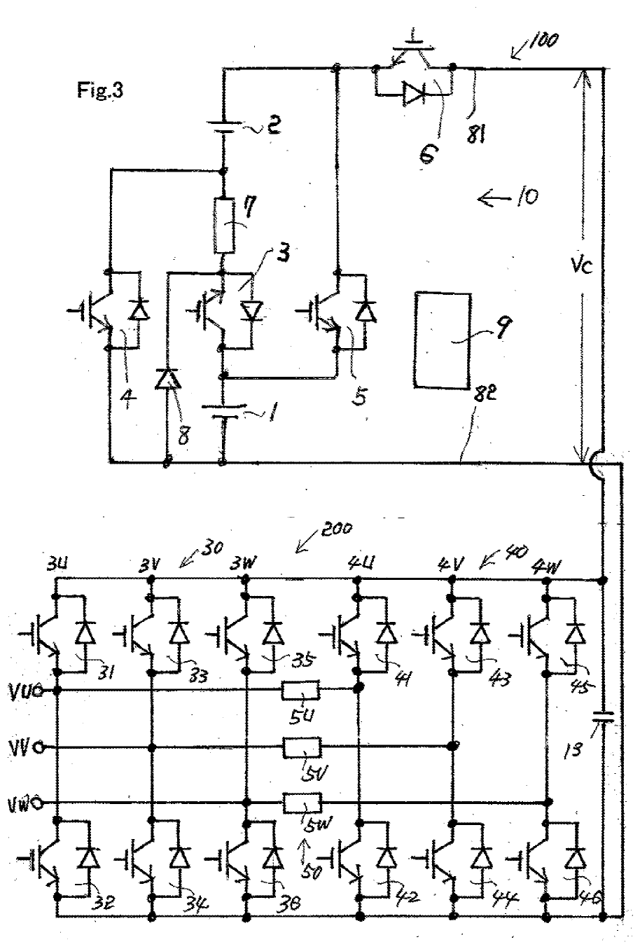

FIG. 3 is a wiring diagram for showing an on-board charger of voltage-changing type. DC power supply 100, which applies power-supply voltage Vc to dual inverter 200, consists of a battery 1, a battery 2, and a connection-changing circuit 10. Each rated voltage of the batteries 1 and 2 is 180V. The connection-changing circuit 10 consists of a series transistor 3, parallel transistors 4 and 5, an outputting transistor 6, a reactor 7, and a diode 8. Each of the transistors 3 to 6 consists of an IGBT with an anti-parallel diode.

The positive power-supply line 81 is connected to the negative power-supply line 82 through outputting transistor 6, battery 2, reactor 7, series transistor 3, and battery 1. A connection point of reactor 7 and a negative electrode of battery 2 is connected to negative power supply line 82 through parallel transistor 4. A connection point of the outputting transistor 6 and an anode electrode of battery 2 is connected to an anode electrode of battery 1 through parallel transistor 5. A connection point of reactor 7 and series transistor 3 is connected to an cathode electrode of the diode 8. An anode electrode of diode 8 is connected to negative power-supply line 82.

This on-board charger of voltage-changing type is same as the on-board charger of the first embodiment except operation of connection-changing circuit 10. Therefore, only the operation of the connection-changing circuit 10 in the charging mode is explained. The charging mode of connection-changing circuit 10 has a parallel mode, a series mode, and a voltage-dropping mode. Connection-changing circuit 10 employs the parallel mode when battery 101 is connected to the single-phase grid with less than 125V. Connection-changing circuit 10 employs the series mode when battery 101 is connected to the single-phase grid or the three-phase grid with less than 250V. Connection-changing circuit 10 employs the voltage-dropping mode when battery 101 is connected to the three-phase grid with less than 480V.

In the parallel mode, transistor 3 is turned off, and transistors 4 to 6 are turned on. Thus, each of battery 1 and 2 are connected to dual inverter 200 in parallel. Power-supply voltage Vc becomes 180V. Legs 3V and 3W of inverter 30 execute the stepping-up operation in turn.

Moreover, the parallel mode has a voltage-equalizing mode. In the voltage-equalizing mode, an voltage difference between batteries 1 and 2 is detected before starting of the parallel mode. Only the parallel transistor, which is connected to the battery with lower voltage is turned on when the voltage difference is larger than a predetermined value. Thus, only the battery with lower voltage is charged. Two parallel transistors 4 and 5 are turned on after the voltage difference is lower than the predetermined value. Thus, two batteries 1 and 2 are charged in parallel. Therefore, it is protected that a short-circuiting current flows through batteries 1 and 2 just after the starting of the parallel mode.

In the series mode, transistors 4 and 5 are turned off. Transistors 3 and 6 are turned on. Thus, power-supply voltage Vc becomes 360V. Legs 3V and 3W of inverter 30 execute the stepping-up operation in turn when the single-phase AC voltage is applied. Legs 3U, 3V and 3W of inverter 30 execute the stepping-up operation in turn when the three-phase AC voltage is applied. In the voltage-dropping mode, transistor 3 is turned on. Transistor 6 is controlled by PWM method. Thus, connection-changing circuit 10 steps down the rectified voltage applied from three-phase inverter 40. This stepping-down motion is explained. The charging current flows from power-supply line 81 to power-supply line 82 through transistor 6, battery 2, reactor 7, transistor 3, and battery 1. As a result, batteries 1 and 2 are charged to series.

A first free-wheeling current is circulated through reactor 7, transistor 3, transistor 5, and battery 2 by magnetic energy accumulated in reactor 7 when transistor 6 is turned off. Further, a second free-wheeling current is circulated through reactor 7, transistor 3, battery 1, and transistor 4. Batteries 1 and 2 are charged in parallel by these freewheeling current. A PWM duty ratio of transistor 6 is adjusted for controlling of the charging current.

### The Third Embodiment

Connection-changing circuit 10 of the second embodiment increases manufacturing cost of DC power supply 100. This problem is improved by using connection-changing circuit 10 for motor-driving. In the motor-driving, connection-changing circuit 10 has a parallel mode MP, a series mode MS, and voltage-boosting mode MB. Moreover, connection-changing circuit 10 has a transient mode and a regenerative braking mode.

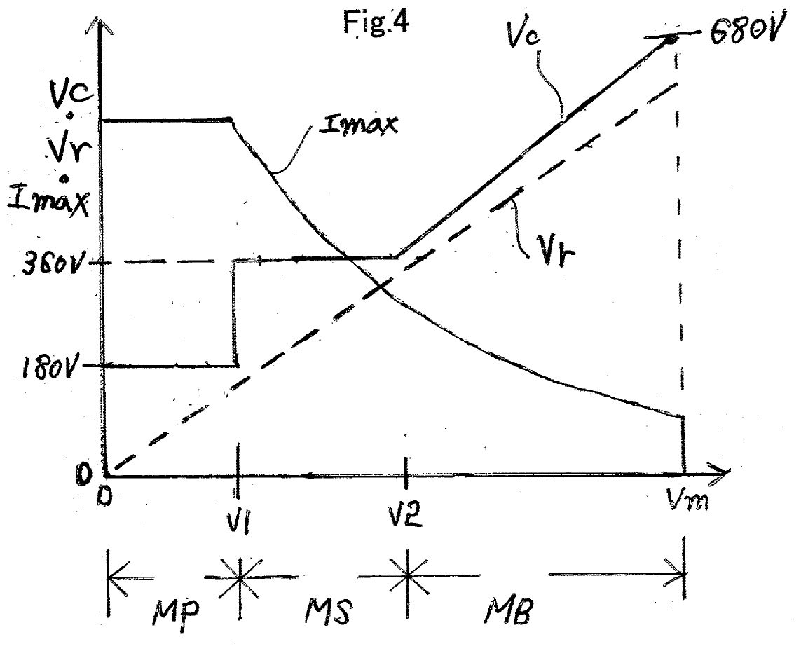

FIG. 4 is a configuration for showing the relation among an anti-electromotive force Vr, a motor speed Vm, and a power-supply voltage Vc.

The parallel mode MP is employed in a low speed range in which the motor speed Vm is lower than a speed value V1. The series mode MS is employed in a middle speed range from V1 to V2. The voltage-boosting mode MB is employed in a high speed range in which the motor speed Vm is higher than a speed value V2. Batteries 1 and 2 are connected in parallel in the parallel mode MP, and are connected to series in the series mode MS.

Transistor 3 is turned off in parallel mode MP. In the series mode MS, transistors 4 and 5 are turned off, and transistor 3 is turned on. Thus, power-supply voltage Vc becomes a voltage sum of batteries 1 and 2.

The parallel mode MP has a voltage-equalizing mode. In the voltage-equalizing mode, an voltage difference between batteries 1 and 2 is detected before starting of the parallel mode. Only the parallel transistor, which is connected to the battery with higher voltage is turned on when the voltage difference is higher than a predetermined value. Or, parallel transistors 4 and 5 are turned off. Thus only the battery with higher voltage is discharged through anti-parallel diode of the parallel diode. Two batteries 4 and 5 are discharged in parallel after the voltage difference is lower than the predetermined value.

In voltage-boosting mode MB, transistor 3 is turned on, and transistors 4 and 5 are controlled by PWM method. Voltage-boosting mode MB consists of an accumulating mode and an outputting mode, which are executed in turn.

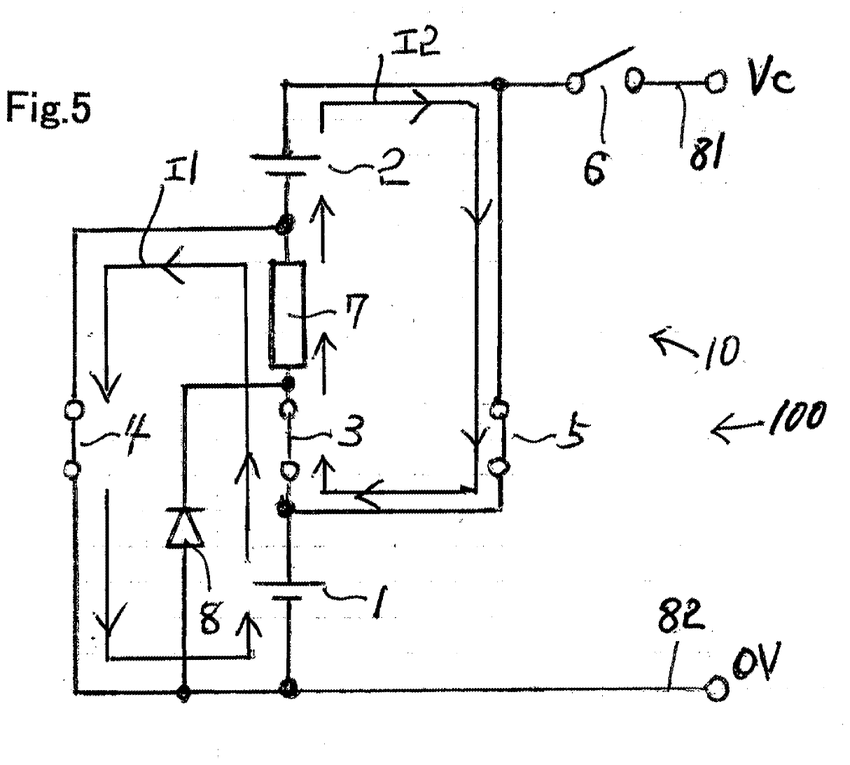

The accumulating mode is explained referring to FIG. 5. Transistor 6 is turned off, and transistors 4 and 5 are turned on. A circulating current 11, which flows through battery 1, transistor 3, reactor 7, and transistor 4, is increased. Magnetic energy accumulated in reactor 7 is increased. Similarly, A circulating current 12, which flows through battery 2, transistor 5, transistor 3, and reactor 7 is increased. Magnetic energy accumulated in reactor 7 is increased.

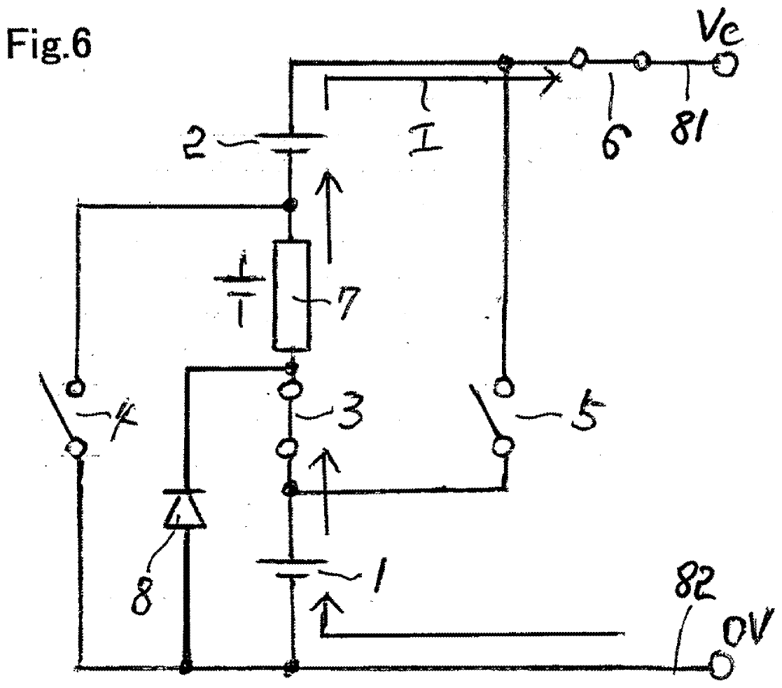

The outputting mode is explained referring to FIG. 6. Transistors 4 and 5 are turned off. A sum of the circulating currents I1 and I2 are supplied to the inverter through transistor 6. Power-supply voltage Vc becomes a sum of battery 1, reactor 7, and battery 2. Power-supply voltage Vc is controlled by adjusting each PWM duty ratio of transistors 4 and 5. After all, connection-changing circuit 20 is operated as a stepping-up DCDC converter.

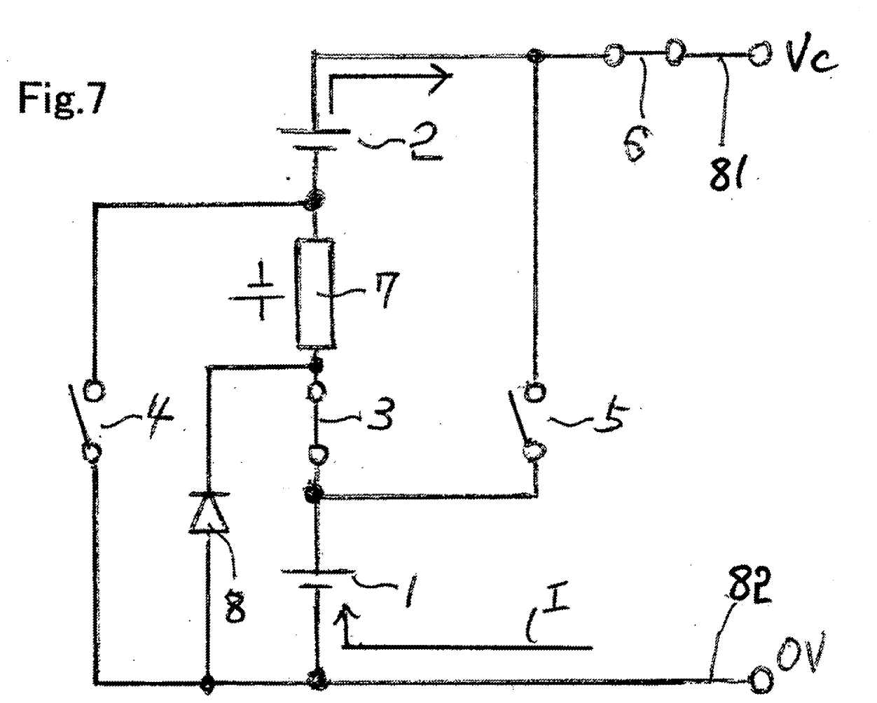

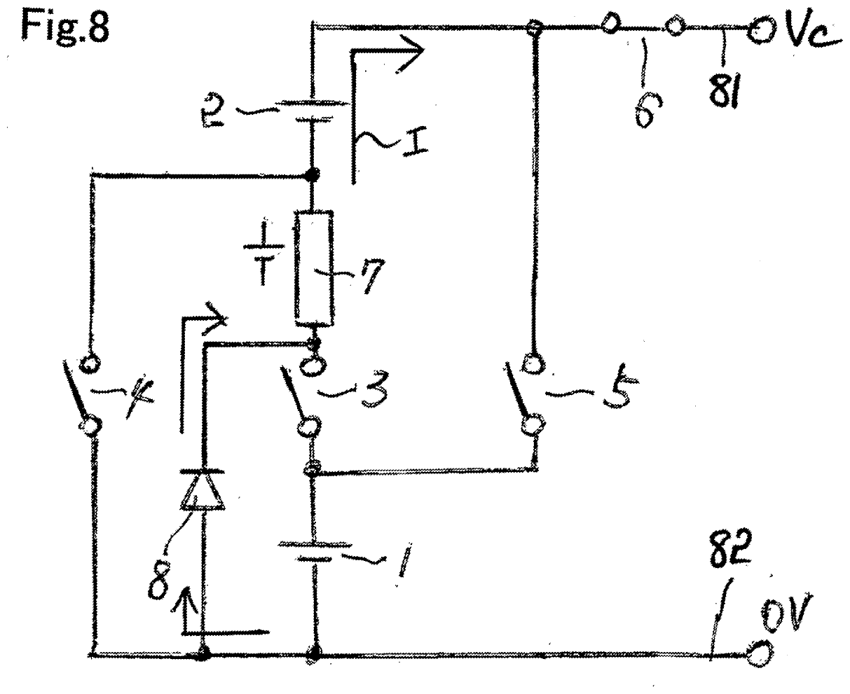

The transient mode is explained referring to FIGS. 7 and 8. Transistors 4 and 5 are turned off, and transistor 3 is controlled by PWM method. FIG. 7 shows an accumulating period in which transistor 3 is turned on. The accumulating period is essentially same as the series mode. Power-supply voltage Vc becomes a voltage sum of battery 1, reactor 7, and battery 2. Reactor 7 induces an back electromotive force to restrain the increasing of a power-supply current I. Thus, power-supply voltage Vc becomes lower than a voltage sum of battery 1 and 2.

FIG. 8 shows a demagnetizing period in which transistor 3 is turned off. Reactor 7 supplies the power-supply current I through diode 8, reactor 7, battery 2, and transistor 6. Reactor 7 generates a voltage a direction of which is same as battery 2. Thus power-supply voltage Vc becomes higher than the voltage of battery 1 or the voltage of battery 2.

In the transient mode in which it is indicated the changing from the parallel mode to the series mode, an on-duty ratio of transistor 3 is gradually changed from 0 to 1. Thus, power-supply voltage Vc becomes gradually high. In the transient mode in which it is indicated the changing from the series mode to the parallel mode, the on-duty ratio of transistor 3 is gradually changed from 1 to 0. Thus, power-supply voltage Vc becomes gradually low.

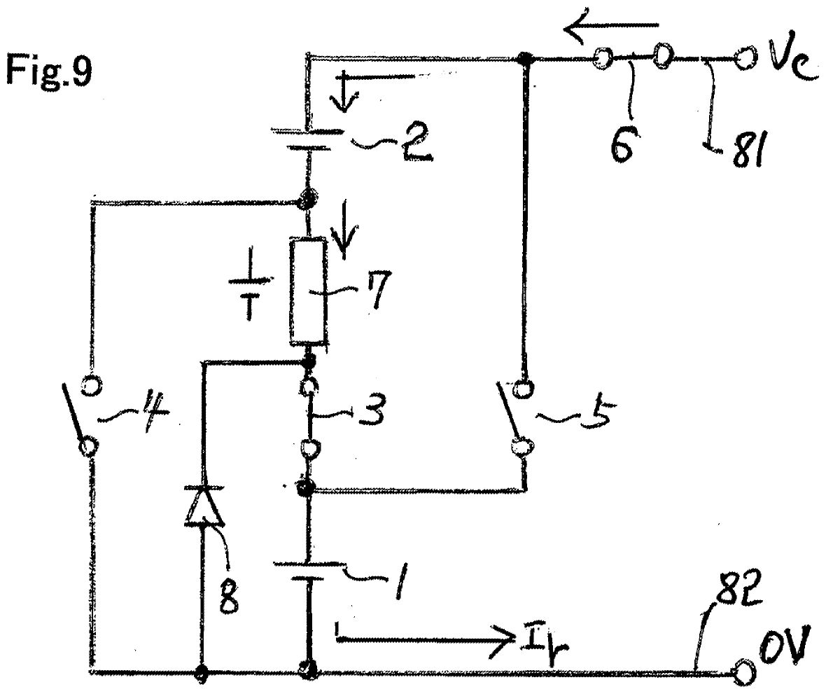

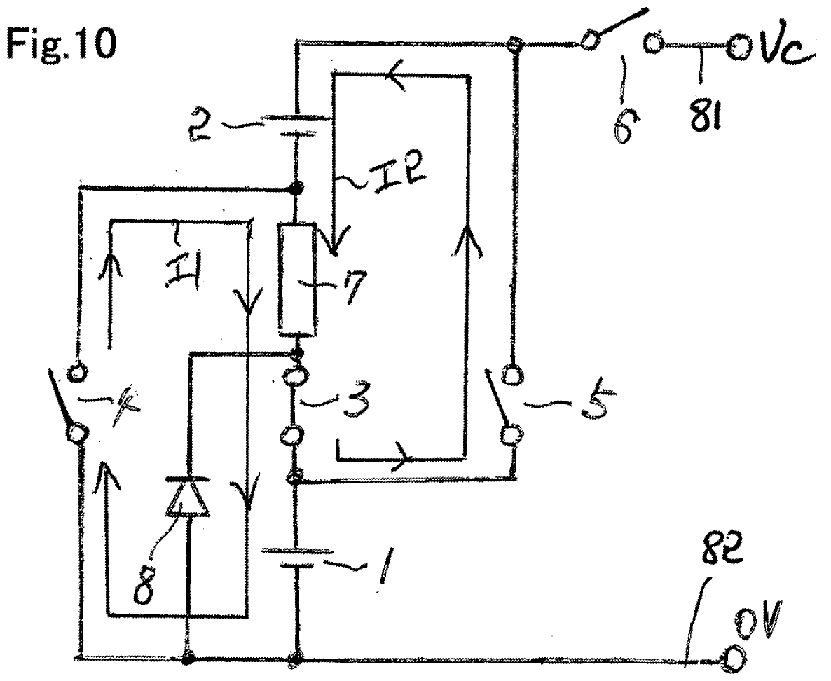

The regenerative braking mode which is equal to the voltage-dropping mode is explained referring to FIGS. 9 and 10. In the regenerative braking mode, transistor 3 is turned on, transistors 4 and 5 are turned off, and transistor 6 is controlled by PWM method. it is capable to abbreviated the turning-on of transistor 3 because of the turning on of an anti-parallel diode of transistor 3.

FIG. 9 shows an accumulating period in which transistor 6 is turned on. Power-supply voltage Vc is applied to battery 2, reactor 7, and battery 1.

Batteries 1 and 2 are charged in series by a regenerative current Ir. Reactor 7 accumulates magnetic energy. A voltage difference between power supply voltage Vc and a voltage sum of batteries (1 and 2) is absorbed by reactor 7.

FIG. 10 shows a freewheeling period in which transistor 6 is turned off. Freewheeling currents (I1,I2) are circulated by reactor 7. The freewheeling current I1, which flows through rector 7, transistor 3, battery 1, and transistor 4, charges battery 1. The freewheeling current I2, which flows through rector 7, transistor 3, transistor 5, and battery 2, charges battery 1. The freewheeling currents I1 and I2 flows through anti-parallel diodes of transistors 4 and 5. It is capable to turn-on transistors 4 and 5. After all, connection-changing circuit 10 becomes the voltage-dropping chopper.

Connection-changing circuit 10 further executes a trouble measure of batteries 1 and 2. Connection-changing circuit 10 separates a bad battery when either one of batteries 1 or 2 is bad, but the other one is normal. Transistors 3 and 5 are turned off, and transistor 4 is turned on when battery 1 is bad. Similarly, transistors 3 and 4 are turned off, and transistor 5 is turned on when battery 2 is bad. After all, connection-changing circuit 10 drives the normal battery by the parallel mode. Thus, it is realized to drive a traction motor although one of two batteries 1 and 2 is troubled.

According to the voltage-changing DC power supply of the embodiment, an equivalent resistance value of the batteries in the parallel mode becomes ¼ in comparison with the series mode. Accordingly, it is capable to reduce power losses of the batteries. The number of turns of the motor is capable to be increased by the voltage-boosting mode. Thus, power loss of the inverter is capable to be reduced. Reactor 7 does not generate power loss in the parallel mode. This voltage-changing DC power supply, which uses only one reactor, reduces copper loss of the reactor in comparison with a prior voltage-changing DC power supply, which uses two reactors.

### The Fourth Embodiment

The second and third embodiments use the voltage-changing DC power supply power supply voltage Vc of which is changed. However, an electric vehicle has a sub battery with a low voltage, which charged by the DC power supply. The sub battery must be charged by using a stable charging voltage in spite of the changing of power-supply voltage Vc. Generally, the sub battery has a voltage about 14.4V.

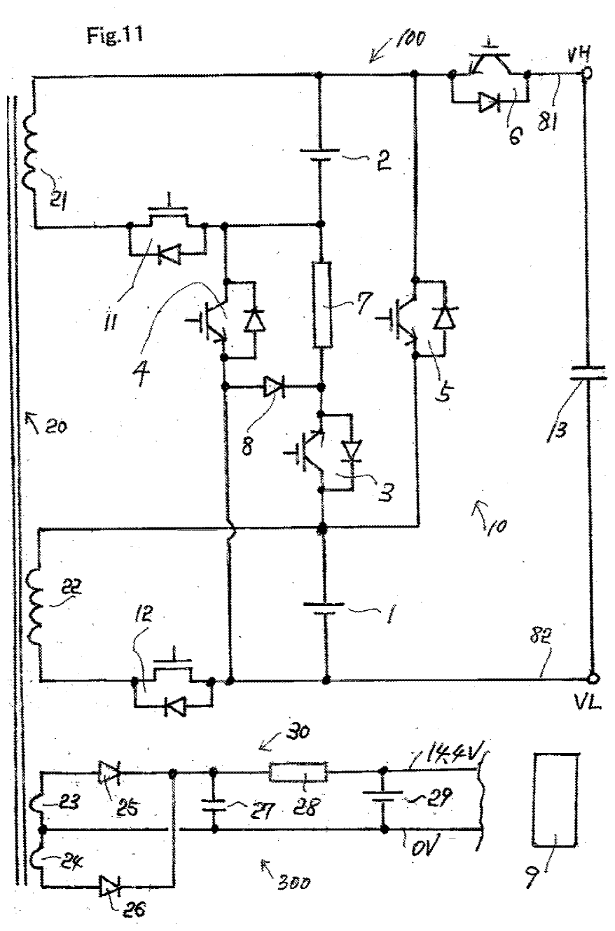

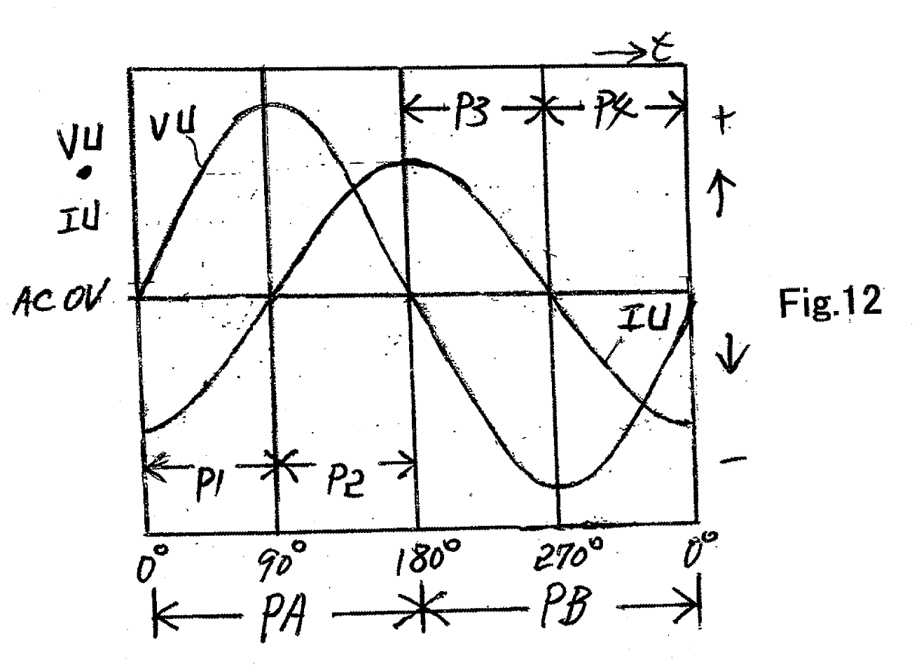

FIG. 11 is a wiring diagram for showing a voltage-dropping DCDC converter which charges a sub battery 29. The voltage-dropping DCDC converter means a step-down DCDC converter. The voltage-boosting DCDC connector means a step-up DCDC converter. The voltage-dropping DCDC converter has transistors (11 and 12), a transformer 20, and a rectifier 30. The transformer 20 has two primary coils (21 and 22) and two secondary coils (23 and 24). Winding directions of the primary coils 21 and 22 are opposite each other. Winding directions of the secondary coils 23 and 24 are opposite each other.

The rectifier 30 consists of two rectifying diodes (25 and 26), a smoothing capacitor 27, and an inductor 28. A smoothing circuit, which consists of the smoothing capacitor 27 and the inductor 28 smooths a rectified voltage which is outputted from the rectifying diodes (25 and 26). The smoothed and rectified voltage is applied to the sub battery 29. The secondary coil 23 is connected to the diode 25, and the secondary coil 24 is connected to the diode 26. The transistor 11 controls an input voltage applied from battery 2 to the primary coil 21. The transistor 12 controls an input voltage applied from battery 1 to the primary coil 22. Transistors 11 an 12 are controlled by PWM method in turn.

A secondary voltage induced across the secondary coil 23 in a period in which transistor 11 is turned on charges the smoothing capacitor 27 through diode 25. A secondary voltage induced across the secondary coil 24 in a period in which transistor 12 is turned on charges the smoothing capacitor 27 through diode 26. The voltage-dropping DCDC converter of the embodiment is not affected by the connection-changing operation of connection-changing circuit 10.

### The Fifth Embodiment

A Li-ion battery preferably employed as battery 101 of the first embodiment deteriorates quickly under cold atmosphere by fast charging. In this embodiment, the power system has a battery-heating mode for heating a cold battery. The battery-heating mode is executed when the battery temperature of a stopped electric vehicle is lower than a predetermined value. Thus, the battery 101 is capable to be charged by the fast charging.

The battery-heating mode is explained referring to FIG. 1. The dual inverter 200 applies a single-phase AC voltage to three-phase coil 50. A fundamental wave component of the single-phase AC voltage has a frequency value which is for example 60 Hz. An electric resistance is ignored, and three-phase coil 50 is regarded as an inductive load. The U-phase H-bridge consisting of legs 3U and 4U applies phase voltage VU to phase coil 5U. A phase current IU flows through phase coil 5U. A fundamental component of phase voltage VU has a sinusoidal waveform for reducing iron losses.

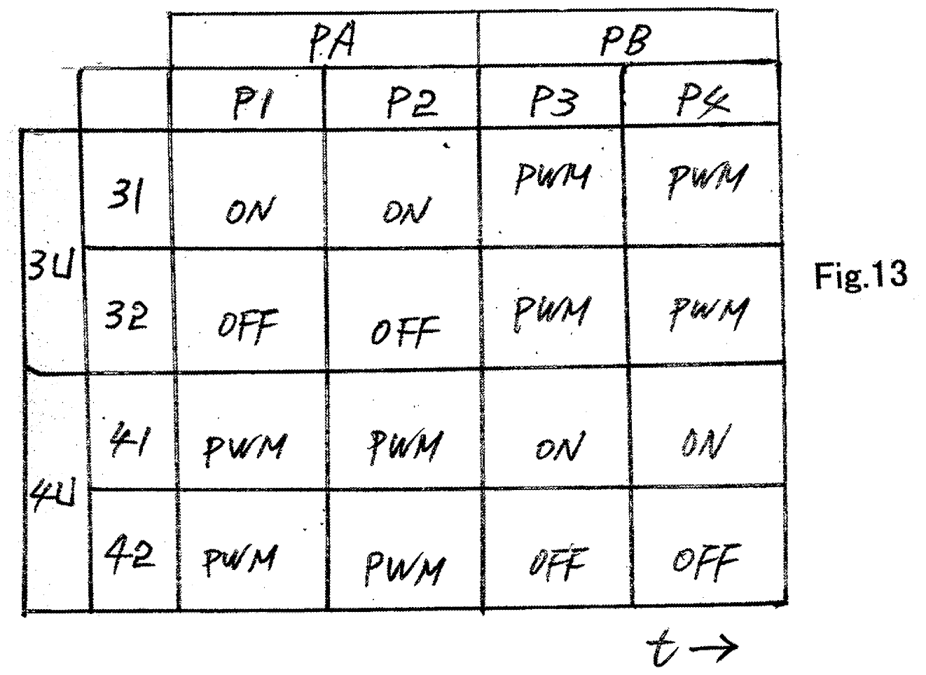

FIG. 12 shows waveforms of the phase current IU and a fundamental wave component of phase voltage VU. A phase difference between phase current IU and phase voltage VU becomes approximately 90 electrical degrees. One period (=360 electrical degrees) of phase voltage VU is divided to a positive half-wave period PA and a negative half-wave period PB. The period PA is divided to phase periods P1 and P2. The period PB is divided to phase periods P3 and P4. In the phase periods P1 and P3, phase current IU flows from phase coil 3U to DC power supply 100. In the phase periods P2 and P4, phase current IU flows from DC power supply 100 to phase coil 3U.

In other words, demagnetizing periods P1 and P3, in which magnetic energy accumulated in inductance of phase coil 5U, the magnetic energy charges a battery. Magnetizing periods P2 and P4, in which magnetic energy of phase coil 5U is increased, the battery is discharged. This charging current and discharging current heat the cold battery which has relatively higher resistance value in comparison with dual inverter 200 and three-phase coil 50. This heating is restrained by the PWM-controlling of legs 3U and 4U.

FIG. 12 is a timing chart for showing one PWM-driving method of legs 3U and 4U. This method is called the upper-arm-conduction type single PWM. One cycle period of U-phase voltage VU consists of the positive half-wave period PA and the negative half-wave period PB. Positive half-wave period PA consists of phase periods P1 and P2. Negative half-wave period PB consists of phase periods P3 and P4.

In the phase period P1, directions of phase voltage VU and phase current IU are opposite each other. The upper arm switch 31 are turning on, and leg 4U is controlled by PWM method. In a period in which upper arm switch 41 is turned off, and lower arm switch 42 is turned on, DC power supply 100 is charged by phase current IU. In a freewheeling period in which upper arm switch 41 is turned on, and lower arm switch 42 is turned off, phase current IU circulates through upper arm switches 31 and 41.

In the phase period P2, directions of phase voltage VU and phase current IU are same each other. The upper arm switch 31 are turning on, and leg 4U is controlled by PWM method. In a period in which upper arm switch 41 is turned off, and lower arm switch 42 is turned on, DC power supply 100 is discharged. In a freewheeling period in which upper arm switch 41 is turned on, and lower arm switch 42 is turned off, phase current IU circulates through upper arm switches 31 and 41.

In the phase period P3, directions of phase voltage VU and phase current IU are opposite each other. The upper arm switch 41 are turning on, and leg 3U is controlled by PWM method. In a period in which upper arm switch 31 is turned off, and lower arm switch 32 is turned on, DC power supply 100 is charged by phase current IU. In a freewheeling period in which upper arm switch 31 is turned on, and lower arm switch 32 is turned off, phase current IU circulates through upper arm switches 31 and 41.

In the phase period P4, directions of phase voltage VU and phase current IU are same each other. The upper arm switch 41 are turning on, and leg 3U is controlled by PWM method. In a period in which upper arm switch 31 is turned off, and lower arm switch 32 is turned on, DC power supply 100 is discharged. In a freewheeling period in which upper arm switch 31 is turned on, and lower arm switch 32 is turned off, phase current IU circulates through upper arm switches 31 and 41. After all, according to the battery-heating mode, battery 101 is charged and discharged with a doubled frequency of phase voltage VU.

Phase current IU produces an alternating magnetic field. The alternating magnetic field essentially consists of two single-phase rotating magnetic fields rotating directions of which are opposite each other. A rotor of a three-phase motor, which is stopped, does not generate the starting torque by the alternating magnetic field. Temperature of the battery is kept in a suitable range by controlling amplitude and/or frequency of phase current IU in accordance with the battery temperature. Therefore, according to the battery-heating mode, it is capable to heat the battery without generating the starting torque.

A first arranged embodiment is explained. Leg 3V execute same PWM-controlling as leg 3U. Leg 4V execute same PWM-controlling as leg 4U. Thus, U-phase current IU further flows through V-phase coil 5V. As a result, it is capable to reduce losses of dual inverter 200 and three-phase coil 50. However, it is not preferable to supply same phase currents to three phase coils 5U, 5V, and 5W. Because three phase magnetic field, which are produced by phase coils 5U, 5V, and 5W, are canceled each other.

A second arranged embodiment is explained. According to this arranged embodiment, a conventional three-phase inverter and a conventional star-shaped three-phase coil with a neutral point are employed instead of the dual inverter 200 and three-phase coil 50. The conventional three-phase inverter consists of a U-phase leg, a V-phase leg, and a W-phase leg. The conventional star-shaped three-phase coil with a neutral point consists of a U-phase coil, a V-phase coil, and a W-phase coil

a single-phase AC voltage with a sinusoidal-wave fundamental wave component is applied to the U-phase coil and the V-phase coil, which are connected to series, by the PWM-controlling of the U-phase leg and the V-phase leg of the conventional three-phase inverter. Accordingly, the U-phase coil and the V-phase coil connected to series are capable to be regarded as an inductive load. The U-phase leg of the three-phase inverter is equivalent to leg 3U of dual inverter 200 shown in FIG. 1. Similarly, The V-phase leg of the three-phase inverter is equivalent to leg 4U of dual inverter 200 shown in FIG. 1. Therefore, it is capable to supply a single-phase AC current to the U-phase coil and the V-phase coil connected to series by the controlling of the U-phase leg and the V-phase leg with PWM method.

### The Sixth Embodiment

The dual inverter employed by the first embodiment needs the doubled number of switches in comparison with a conventional three-phase inverter. This demerit is restrained by improving merits of the dual inverter. This embodiment discloses a novel driving method of the dual inverter capable to reduce power losses.

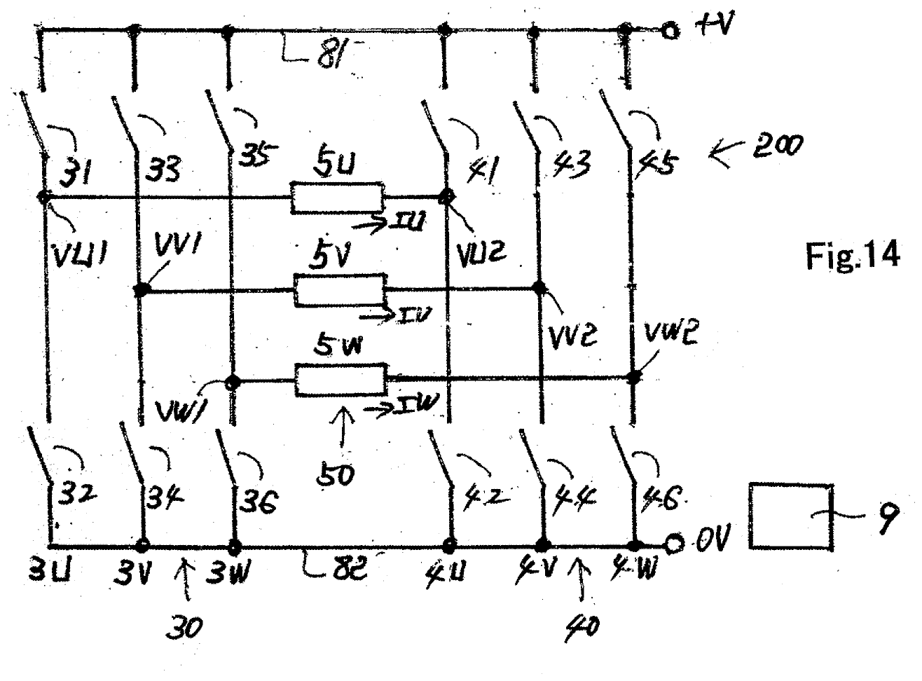

FIG. 14 shows dual inverter 200 connected to double-ended three-phase coil 50. Dual inverter 200 drives a three-phase traction motor of an electric vehicle. This dual inverter 200 is same as dual inverter 200 of the first embodiment shown in FIG. 1. Thus, explanation of dual inverter 200 and three-phase coil 50 are abbreviated

Leg 3U applies a U-phase voltage VU1 to phase coil 5U. Leg 4U applies a U-phase voltage VU2 to phase coil 5U. Thus, a U-phase voltage VU (=VU1−VU2) are applied to phase coil 5U. Leg 3V applies a V-phase voltage W1 to phase coil 5V. Leg 4V applies a V-phase voltage W2 to phase coil 5V. Thus, a V-phase voltage W (=VV1−VV2) are applied to phase coil 5V. Leg 3W applies a W-phase voltage VW1 to phase coil 5W. Leg 4W applies a W-phase voltage VW2 to phase coil 5W. Thus, a W-phase voltage VW (=VW1−VW2) are applied to phase coil 5W. Each phase difference among three-phase voltages (VU, W, and VW) is 120 electrical degrees.

Legs 3U and 4U produces a U-phase H-bridge for applying the U-phase voltage VU to phase coil 5U. Legs 3V and 4V produces a V-phase H-bridge for applying the V-phase voltage VU to phase coil 5V. Legs 3W and 4W produces a W-phase H-bridge for applying the W-phase voltage VW to phase coil 5W. New PWM-driving method of dual inverter 200, which is called the upper-arm-conduction type single PWM method, is explained. Operations of these three H-bridges each phase difference of which is 120 electrical degrees are same each other. Therefore, the PWM-controlling of only U-phase H-bridge is explained.

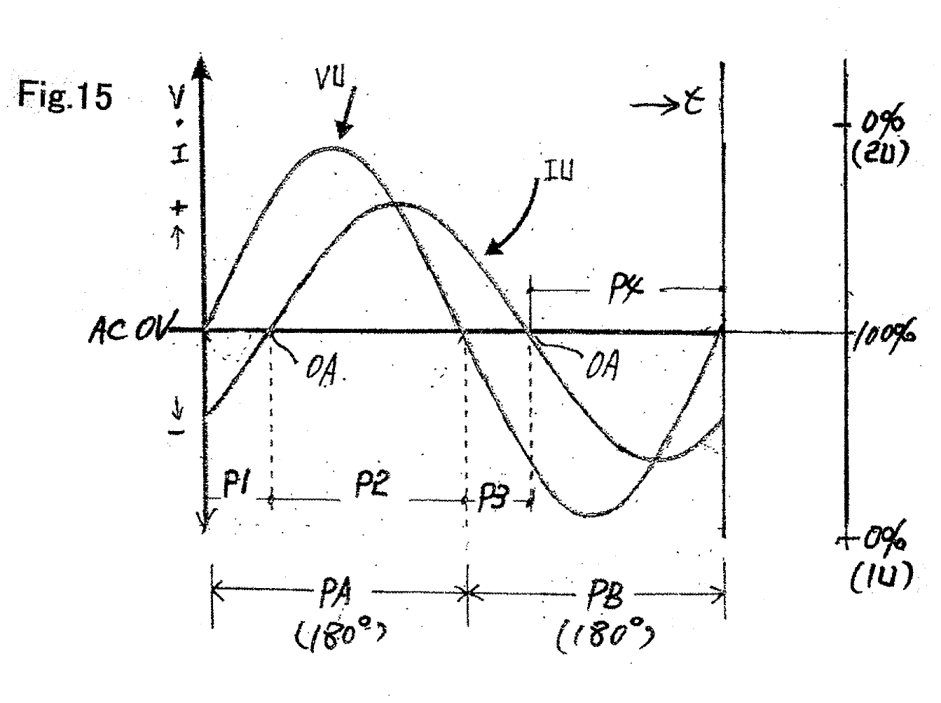

FIG. 15 is a waveform configuration for showing an output current IU and a fundamental wave component of the output voltage VU. FIG. 15 is essentially same as FIG. 13. One period (=360 electrical degrees) of phase voltage VU is divided to a positive half-wave period PA and a negative half-wave period PB. The period PA is divided to phase periods P1 and P2. The period PB is divided to phase periods P3 and P4. The phase periods P1 and P3 are periods in which phase current IU returns from phase coil 5U to a DC power supply. The phase periods P2 and P4 are periods in which phase current IU is supplied from the DC power supply to phase coil 5U.

In the single PWM method of upper-arm-conduction type, legs 3U and 4U are controlled by pulse-width-modulation (PWM) in turn. The H-bridge of each phase consists of a fixed potential leg and a PWM-leg. An upper arm switch of the fixed potential leg is constantly turned on. In period PA, leg 3U becomes the fixed potential leg, and leg 4U becomes the PWM-leg. In period PB, leg 3U becomes the PWM-leg, and leg 4U becomes the fixed potential leg.

The fixed potential leg and the PWM-leg are changed every 180 electrical degrees. Space-vector-modulation method (SVPWM) capable to freely arrange current-supplying periods in each PWM cycle period TC is preferable for the controlling of the PWM-leg

In the SVPWM method, controller 9 produces the current-supplying periods TX every PWM cycle period TC. A PWM duty ratio is equal to a ratio (TX/TC). The other PWM cycle period TC except current-supplying period TX is called the freewheeling period TF. The DC power supply supplies phase current IU to phase coil 5U in current-supplying period TX. A freewheeling current circulates through dual inverter 200 and three-phase coil 50 In the freewheeling period TF.

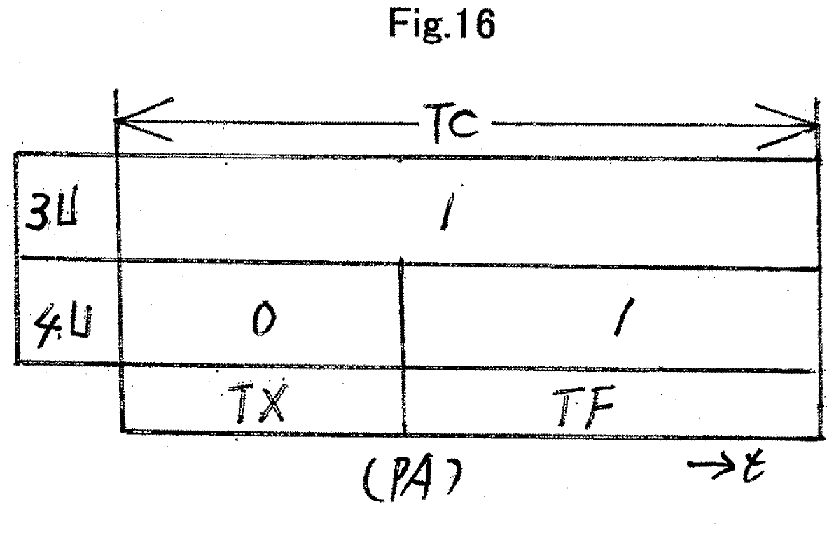

FIG. 16 is a timing chart for showing one PWM cycle period TC in the period PA. Leg 3U, which is the fixed potential leg, outputs a high level (1). Leg 4U, which is the PWM-leg, outputs a low level (0) in current-supplying period TX and outputs a high level (1) in freewheeling period TF,

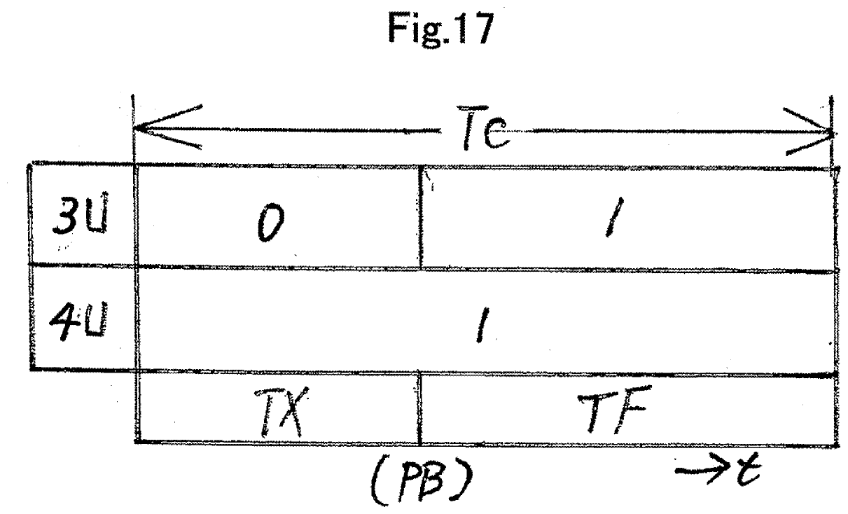

FIG. 17 is a timing chart for showing one PWM cycle period TC in period PB. Leg 4U, which is the fixed potential leg, outputs a high level (1). Leg 3U, which is the PWM-leg, outputs a low level (0) in current-supplying period TX and outputs a high level (1) in freewheeling period TF,

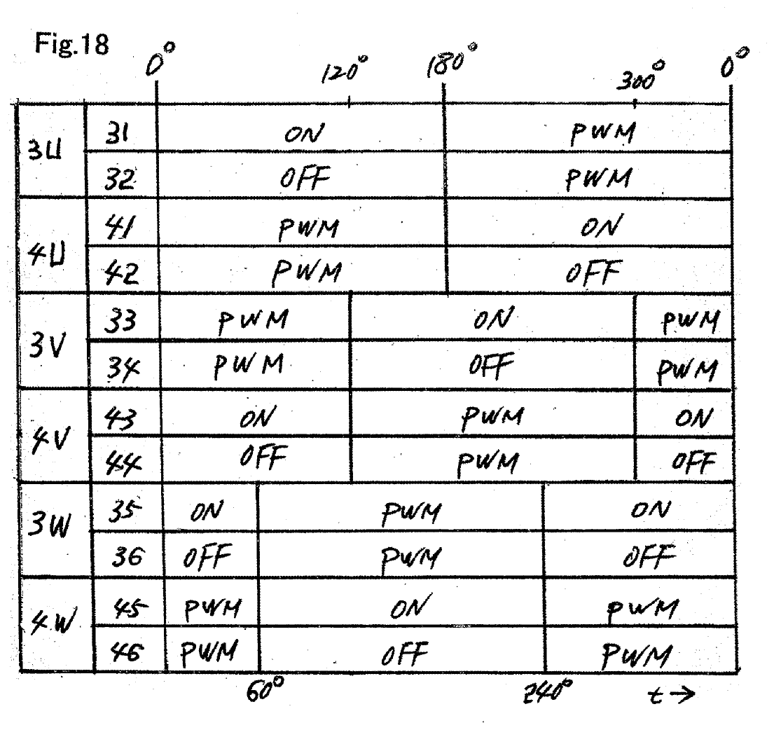

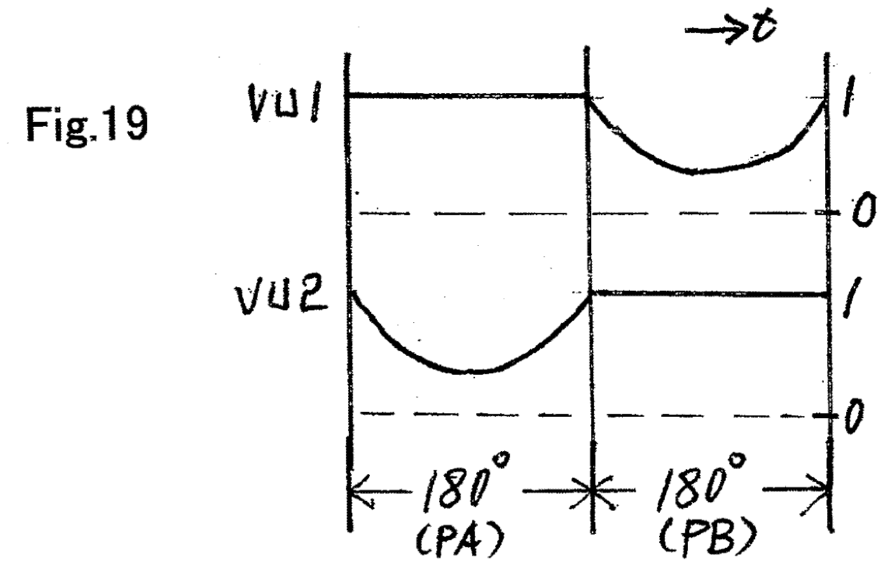

First, a triple H-bridge mode in which three H-bridges are controlled by PWM method is explained. FIG. 18 is a timing chart for showing the triple H-bridge mode. FIG. 19 is a wave configuration for showing each fundamental wave component of an output voltage VU1 and an output voltage VU2. In a triple H-bridge mode, a synthetic rotating voltage vector is produced by three phase voltage vectors.

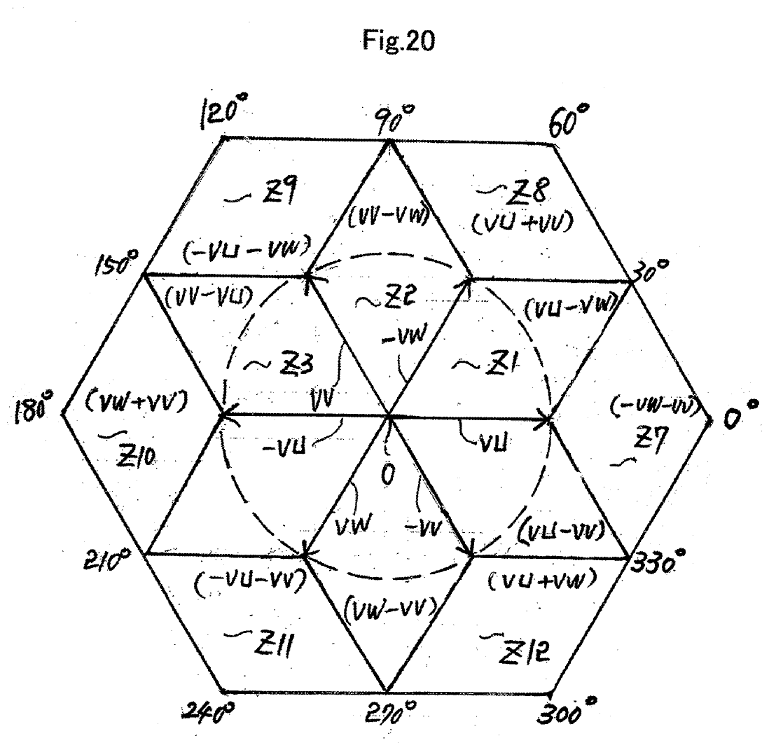

Next, a double H-bridge mode, in which two H-bridges are controlled simultaneously by PWM method, is explained. FIG. 20 is a vector chart for showing an existing are of the synthetic rotating voltage vector in the double H-bridge mode. In the double H-bridge mode, one of three H-bridge is stopped in turn every 60 electrical degrees, and the other two H-bridges are operated by PWM method. 60 electrical degrees show a phase angle of the synthetic rotating voltage vector a direction of which is accord with a direction of a −W-phase voltage-VW. 120 electrical degrees show a phase angle of the synthetic rotating voltage vector a direction of which is accord with a direction of V-phase voltage VV. 180 electrical degrees show a phase angle of the synthetic rotating voltage vector a direction of which is accord with a direction of a −U-phase voltage −VU. 240 electrical degrees shows a phase angle of the synthetic rotating voltage vector a direction of which is accord with a direction of W-phase voltage VW. 300 electrical degrees show a phase angle of the synthetic rotating voltage vector a direction of which is accord with a direction of a V-phase voltage −VV. The synthetic rotating voltage vector is a vector sum of two or three phase voltage vectors.

The U-phase H-bridge consisting of legs 3U and 4U outputs U-phase voltages VU and −VU in turn. The V-phase H-bridge consisting of legs 3V and 4V outputs V-phase voltages W and −VV in turn. The W-phase H-bridge consisting of legs 3W and 4W outputs W-phase voltages VW and −VW in turn.

In FIG. 20, each of six phase voltage vectors (VU, −VU, W, −W, VW, and −VW) has the largest amplitude each. In other words, a circle illustrated with a broken line shown in FIG. 20 shows a state that an amplitude of the synthetic rotating voltage vector is equal to the largest amplitude value of one phase voltage vector. The double H-bridge mode is operated in the circle illustrated with a broken line. The triple H-bridge mode is operated out of the circle illustrated with a broken line.

In FIG. 20, an area in which the synthetic rotating voltage vector is capable to be rotate is divided to twelve phase areas (Z1 to Z12).

In six phase blocks (Z1 to Z6), the synthetic rotating voltage vector is produced by a vector sum of adjacent two phase voltage vectors. Each amplitude of the adjacent two phase voltage vectors is controlled by PWM method.

Phase voltage vector VU is equivalent to current-supplying period TX of the U-phase H-bridge. Phase voltage vector VV is equivalent to current-supplying period TX of the V-phase H-bridge. Phase voltage vector VW is equivalent to current-supplying period TX of the W-phase H-bridge.

For example, the synthetic rotating voltage vector in the phase area Z1 is produced by a vector sum of phase voltage vectors VU and −VW.

After all, in the double H-bridge mode, one H-bridge is stopped, and power losses of dual inverter 200 is reduced. The triple H-bridge mode is operated when the synthetic rotating voltage vector reaches out of the circle illustrated by the broken line.

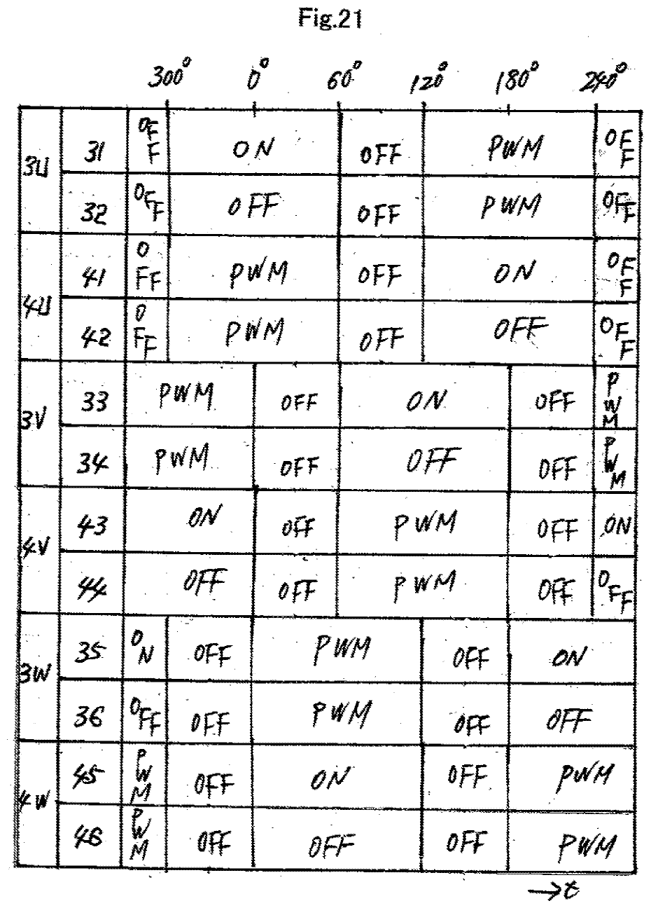

FIG. 21 is a timing chart for showing the double H-bridge mode. Preferably, three H-bridges are controlled by the upper-arm-conduction type single PWM. U-phase legs 3U and 4U are stopped in periods from 60 electrical degrees to 120 electrical degrees and from 240 electrical degrees to 300 electrical degrees. V-phase legs 3V and 4V are stopped in periods from zero electrical degree to 60 electrical degrees and 180 electrical degrees to 240 electrical degrees. W-phase legs 3W and 4W are stopped in periods from 120 electrical degrees to 180 electrical degrees and in a period from 300 electrical degrees to zero electrical degree. Accordingly, the power loss of dual inverter 200 are reduced. It is preferable that the turning-off motions of the upper arm switches for stopping each leg are executed in freewheeling periods in which the freewheeling current flows. Thus, ringing surge voltages are reduced.

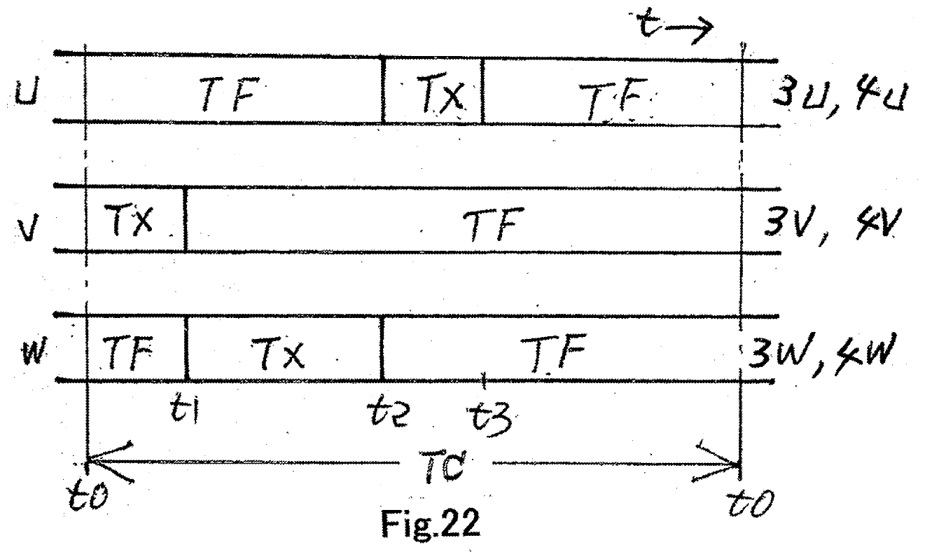

A current dispersion method is explained referring to FIG. 22. The current dispersion method uses an advantage that the dual inverter driven by the space-vector-pulse-width-modulation (SVPWM) is capable to freely arrange the current-supplying periods of three H-bridges in a common PWM cycle period TC. FIG. 22 is a timing chart for showing one PWM cycle period in the triple H-bridge mode. Each current-supplying periods TX of three H-bridges is arranged in a common PWM cycle period. Overlapping of three current-supplying periods TX is avoided as much as possible. Similarly, according to the double H-bridge mode, each current-supplying period TX of two H-bridges is arranged in a common PWM cycle period not to overlap as much as possible.

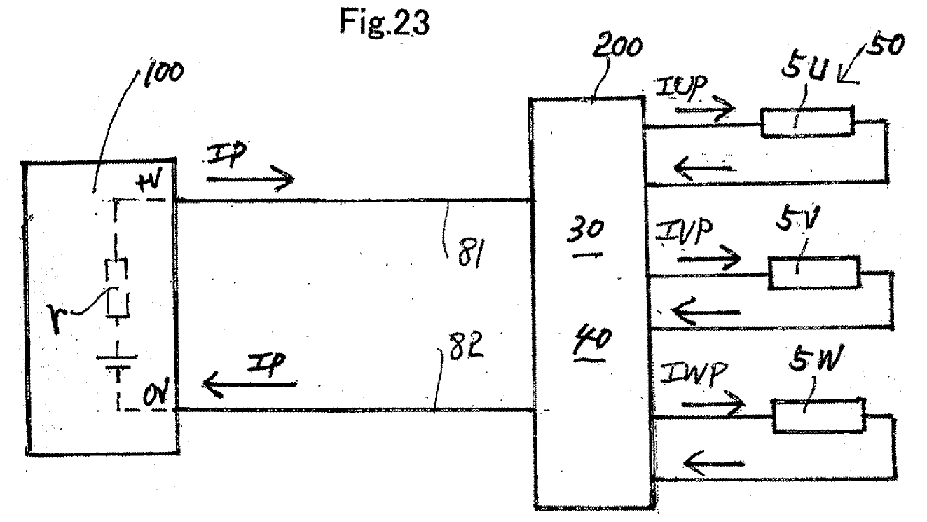

Advantages of the current-dispersion method are explained referring to FIG. 23. Dual inverter 200 driven by the SVPWM method supplies a phase power-supply current IUP to phase coil 5U, supplies a phase power-supply current IVP to phase coil 5V, and supplies a phase power-supply current IWP to phase coil 5W. DC power supply 100 with a power-supply resistance (r) supplies a pulse-shaped power-supply current IP to dual inverter 200 through a positive power-supply line 81 and a negative power-supply line 82. The power-supply current IP is equal to a sum of three phase power-supply currents (IUP, IVP, and IWP). A freewheeling current which flows three-phase coil 50 is ignored.

Resistive power loss of DC power supply 100 become a value (r)(IUP+IVP+IWP)(IUP+IVP+IWP) when three of phase power-supply currents (IUP, IVP, and IWP) are overlapped each other. The resistive power loss of DC power supply 100 becomes a value (r)((IUP)(IUP)+(IVP)(IVP)+(IWP)(IWP)) when three of phase power-supply currents (IUP,IVP,IWP) are not overlapped each other.

For example, it is assumed that each of the V-phase power-supply current IVP and the W-phase power-supply current IWP has a relative amplitude (1), and the U-phase power-supply current IUP has a relative amplitude (2).

The resistive power loss of DC power supply 100 becomes a value (16r) when phase power-supply currents (IUP, IVP, and IWP) are overlapped each other. The resistive power losses of DC power supply 100 becomes a value (6r) when phase power-supply currents IUP, IVP, and IWP are not overlapped each other Thus, the current-dispersion method largely reduces the resistive power loss of DC power supply 100 in partial load conditions.

For example, each of V-phase power-supply current IVP and W-phase power-supply current IWP has a relative amplitude value (1) when a relative amplitude value of U-phase power-supply current IUP is zero. The resistive power loss of DC power supply 100 becomes a value (4r) when phase power-supply currents IUP, IVP, and IWP are overlapped each other. The resistive power loss of DC power supply 100 becomes a value (2r) when phase power-supply currents IUP, IVP, and IWP are not overlapped each other.

However, each current-supplying period TX of a plurality of phases is overlapped each other when a motor current is increased. Preferably, relatively short current-supplying periods TX are overlapped with precedence in the triple H-bridge mode. Because relatively long current-supplying period TX means that an amplitude f the phase current is high. Thus, the resistive power loss of DC power supply is reduced. Preferably, ending of current-supplying period TX of one phase and starting of current-supplying period TX of another phase are overlapped each other. Thus, ripples of power-supply current IP are reduced. Preferably, current-supplying periods TX of two or three phases are arranged continuously Thus, ripples of power-supply current IP are reduced.

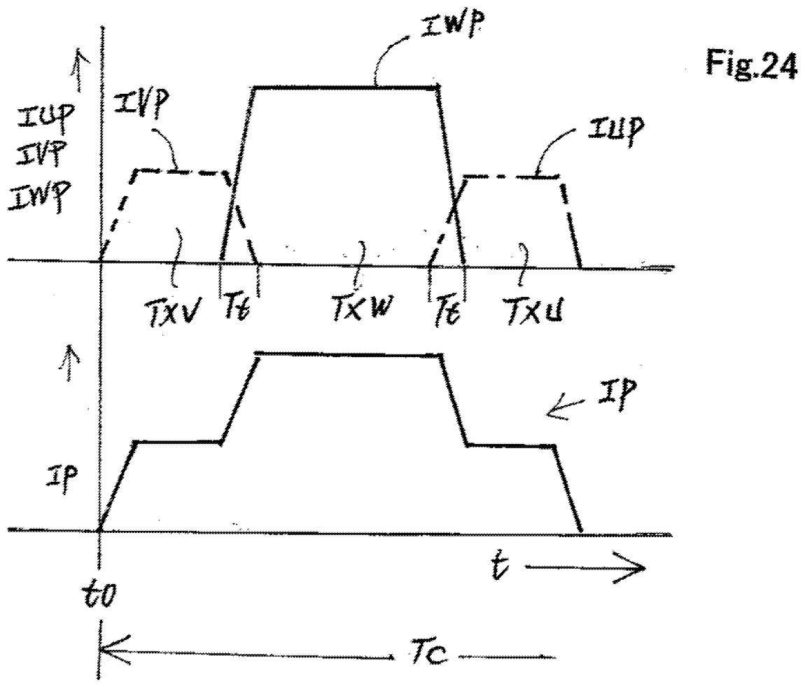

Preferably, the longest current-supplying period TX of one phase is sandwiched by current-supplying periods TX of the other two phases in the triple H-bridge mode. Thus, the ringing surge voltage induced across the positive power-supply line 81 is reduced. In FIG. 24, a longest current-supplying period TXW of W-phase is started from an ending time point of a current-supplying period TXV of V-phase. Similarly, a current-supplying period TXU of U-phase is started from an ending time point of a current-supplying period TXW of W-phase. Thus, it is capable to reduce high-frequency components of power-supply current IP.

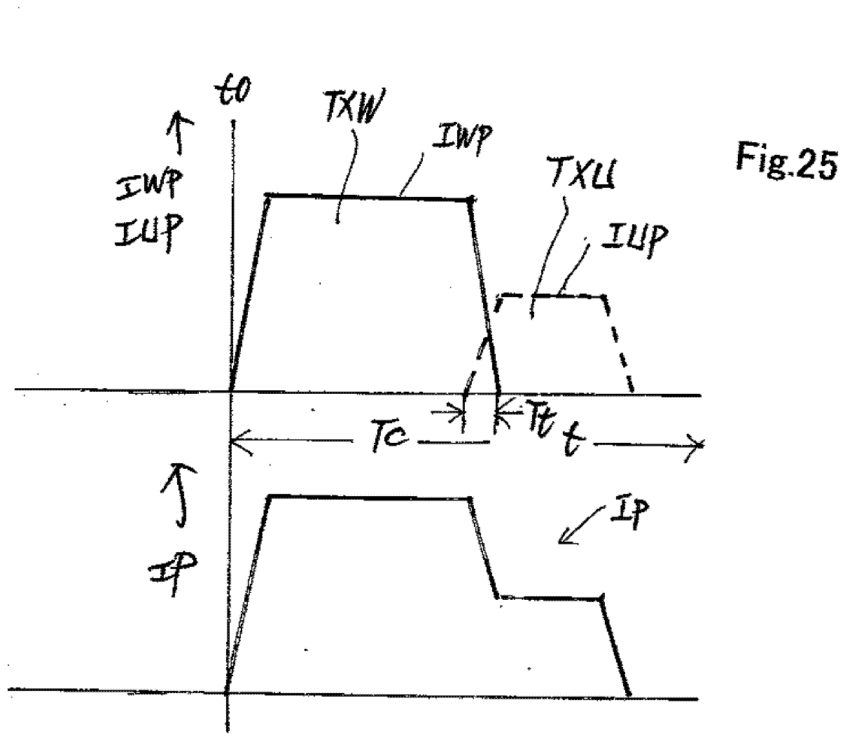

Preferably, longer current-supplying period TX is disposed just before the other one current-supplying period TX in the double H-bridge mode. Thus, it is capable to reduce the ringing surge voltage induced across positive power-supply line 81. In FIG. 25, ending of longer W-phase current-supplying period TXW and starting of U-phase current-supplying period TXU are overlapped. Thus, it is capable to reduce high-frequency components of power-supply current IP are reduced.

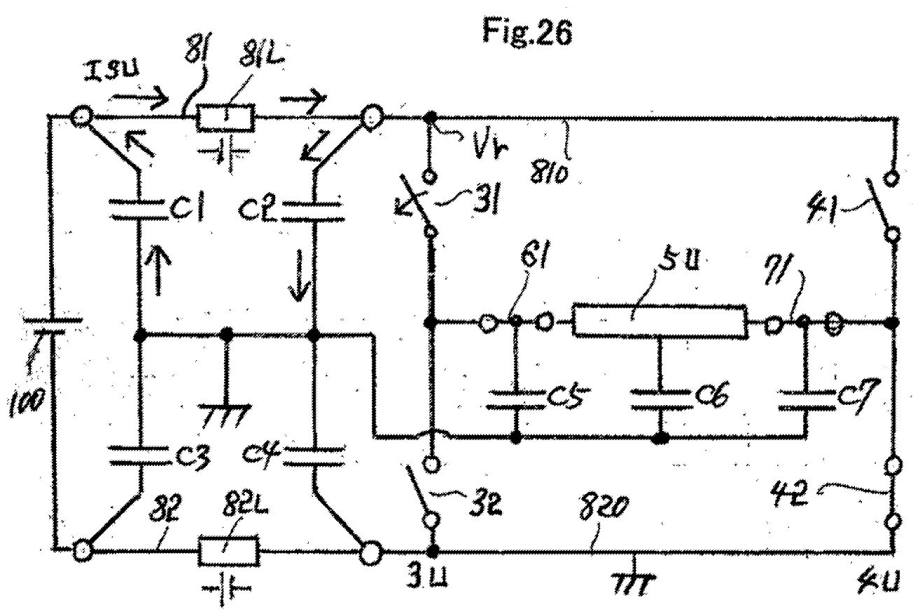

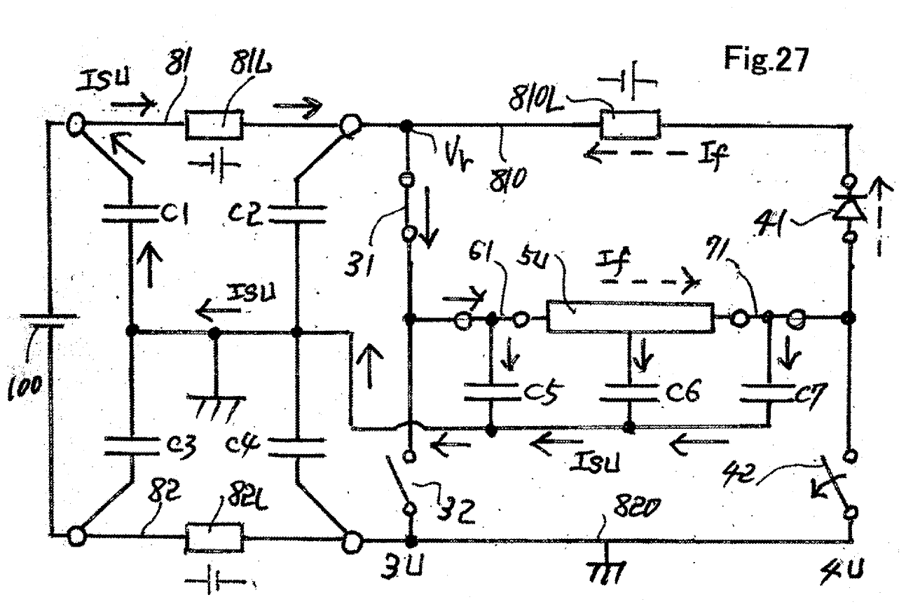

Reduction effect of the ringing surge voltage of dual inverter 200 which employs the upper-arm-conduction single PWM is explained referring to FIGS. 26 and 27. In FIG. 26, U-phase upper arm switch 31 is turned off. In FIG. 27, U-phase lower arm switch 42 is turned off. Upper arm switches 31 and 41 of the U-phase H-bridge are connected each other by a positive bus bar 810 installed in the inverter. Similarly, lower arm switches 32 and 42 of the U-phase H-bridge are connected each other by a negative bus bar 810 installed in the inverter. The positive bus bar 810 is connected to a positive terminal of DC power supply 100 through positive power-supply line 81. The negative bus bar 820 is connected to a negative terminal of DC power supply 100 through negative power-supply line 82.

U-phase coil 5U is connected to leg 3U through a U-phase cable 61, and is connected to leg 4U through a U-phase cable 71. Positive power-supply line 81 has a line inductance 81L, and the negative power-supply line 82 has a line inductance 82L. Both ends of positive power-supply line 81 are grounded respectively through parasite capacitance C1 and parasite capacitance C2. Both ends of negative power-supply line 82 are grounded respectively through parasite capacitance C3 and parasite capacitance C4. The U-phase cable 61 is grounded through a parasite capacitance C5. U-phase coil 5U is grounded through a parasite capacitance C6, and the U-phase cable 71 is grounded through a parasite capacitance C7.

In FIG. 26 in which upper arm switch 31 is turned off, the line inductance 81L induces a surge voltage. The surge voltage supplies a surge current ISU through a series resonance circuit consisting of the parasite capacitance C2 and parasite capacitance C1 and the line inductance 81L. Thus, a high ringing surge voltage Vr is applied to upper arm switch 31.

In FIG. 27 in which lower arm switch 42 is turned off, the line inductance 81L induces a surge voltage. The surge voltage supplies a surge current ISU through a series resonance circuit consisting of parasite capacitance C1 and parasite capacitance C5 to parasite capacitance C7 and line inductance 81L. However, the ringing surge voltage Vr is reduced because upper arm switch 31 is turned on. After all, the upper-arm-conduction type single PWM employed by the dual inverter is capable to reduce the ringing surge voltage.

Next, the surge voltage of the fixed potential leg is explained. In the upper-arm-conduction type single PWM, the upper arm switch is turned off when the fixed potential leg is changed. The turning-off motion of the upper arm switch induces the ringing surge voltage. However, this embodiment executes the turning-off motion of the upper arm switch for changing from the fixed potential leg to the PWM-leg in or just after the freewheeling period TF.

In other words, the upper arm switch stops a freewheeling current If. The freewheeling current If flows through positive bus bar 810 but does not flow through positive power-supply line 81. Positive bus bar 810 has lower inductance value in comparison with positive power-supply line 81. As a result, the ringing surge voltage becomes low.

Effects of the dual inverter of the embodiment are explained. First, the dual inverter, which employs the upper-arm-conduction type single PWM method, has the upper arm switch which is always turned on. Thus, the ringing surge voltage of positive power-supply line 81 is reduced. Second, the dual inverter which employs the current-dispersion method largely reduces the resistive power loss of the DC power supply. Third, the dual inverter which employs the double H-bridge mode further reduces the power loss of the inverter.

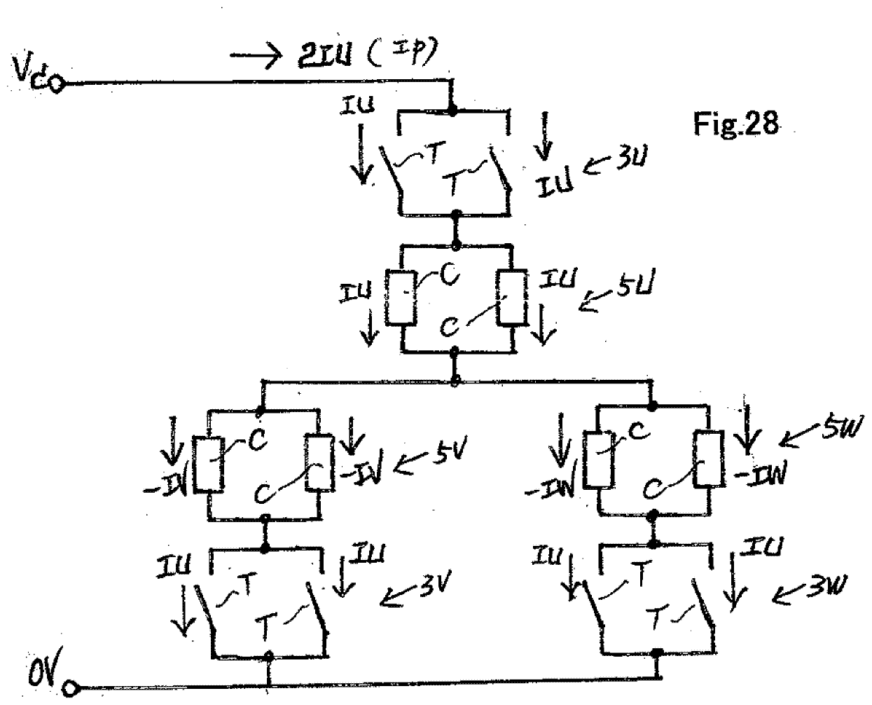

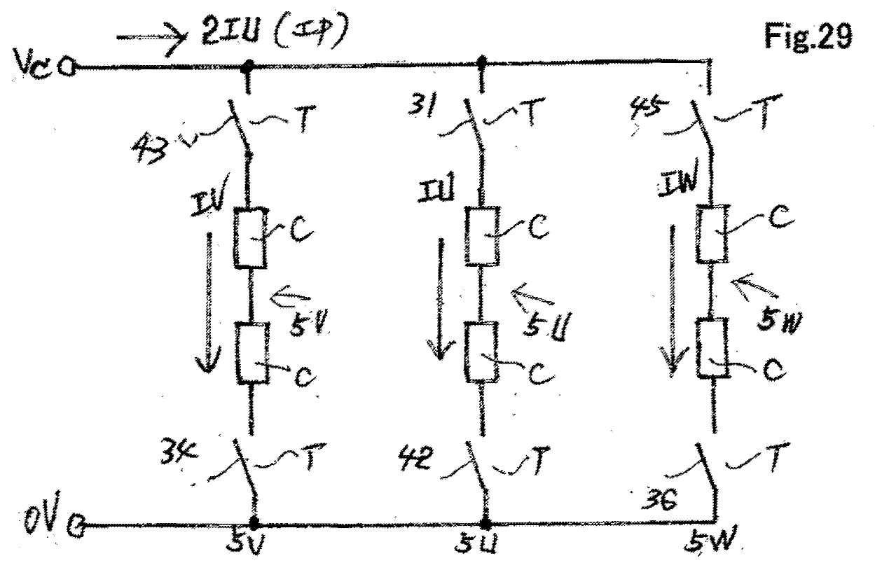

Fourth, the dual inverter and a conventional three-phase inverter are compared referring to FIGS. 28 and 29. FIG. 28 shows a conventional three-phase inverter consisting of U-phase leg 3U, V-phase leg 3V, and W-phase leg 3W. The three-phase inverter is connected to a conventional stator coil consisting of a star-shaped three-phase coil. Each of the three phase coils (5U, 5V, and 5W) of the stator coil consists of two coil units (C,C) connected in parallel. Each of arm switches of the three-phase inverter has two transistors (T, T) connected in parallel. However, FIG. 28 does not show a lower arm switch of the U-phase leg, an upper arm switch of the V-phase leg, and an upper arm switch of the W-phase leg.

FIG. 29 shows the dual inverter driven by the single PWM method of the embodiment. The dual inverter is connected to the double-ended three-phase coil. Each of three phase coils (5U, 5V, and 5W) of the double-ended three-phase coil consists of two coil units (C,C) connected to series. Each switch of the dual inverter has one transistor (T). U-phase current IU is supplied to phase coil 5U through switches 31 and 42. V-phase current IV is supplied to phase coil 5V through switches 43 and 34. W-phase current IW is supplied to phase coil 5W through switches 45 and 36. FIG. 29 does not show the other switches of the dual inverter.

The dual inverter is capable to have a doubled voltage-using rate in comparison with the conventional three-phase inverter. Thus, each phase coil of the double-ended three-phase coil is capable to have the doubled number of turns in comparison with the star-shaped three-phase coil shown in FIG. 28. Accordingly, the dual inverter shown in FIG. 29 has equal circuit scale as the conventional three-phase inverter shown in FIG. 28.

Power losses of the two inverters shown in FIGS. 28 and 29 are compared. Conduction losses of the two inverters are equal each other. However, the dual inverter of single PWM type is capable to have the half number of transistors, which is controlled by PWM method, in comparison with a conventional three-phase inverter. Accordingly, the dual inverter driven by the single PWM has a half of the switching power losses and a half of the recovery losses in comparison with the conventional three-phase inverter. After all, the inverter losses major power losses of which are the switching power losses and the recovery losses are largely reduced.

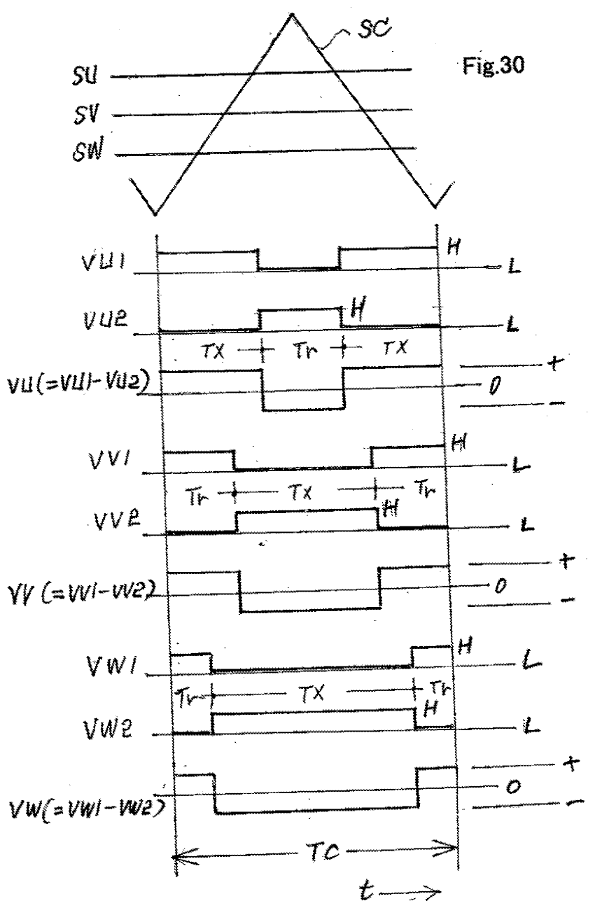

Fifth, the single PWM method of the embodiment reduces the power loss of the dual inverter in comparison with prior double PWM method. FIG. 30 shows each output voltage of six legs in one PWM cycle period TC of the double PWM method. Three comparators (not shown) compare three phase control signals (SU, SV, and SW) and a PWM career signal SC. According to the conventional double PWM method, six PWM-legs output leg-voltages (VU1,VU2,VV1,VV2,VW1, and VW2) in accordance with the comparison result. Each of the leg-voltages (VU1, VU2, W1, W2, VW1, and VW2) is a pulse-shaped voltage which consists of a high level (H) and a low level (L). U-phase voltage VU applied to U-phase coil 5U becomes a U-phase voltage difference (VU1−VU2). V-phase voltage VV applied to V-phase coil 5V becomes a V-phase voltage difference (VV1−VV2). W-phase voltage VW applied to W-phase coil 5W becomes a W-phase voltage difference (VW1−VW2).

According to the double PWM method, each leg has a reverse-voltage-applying period (Tr) for applying a reverse voltage instead of a freewheeling period. As a result, the DC power supply accumulates magnetic energy in an inductance of each phase coil in the current-supplying period (TX). The accumulated magnet energy is regenerated from each phase coil to the DC power supply through the dual inverter in each reverse-voltage-applying period (Tr).

Accordingly, the DC power supply, the dual inverter, and the stator coil generate useless power losses and high-frequency noises by driving the double PWM method. According to the single PWM method which has freewheeling periods (TF) instead of the reverse-voltage-applying periods (Tr), the useless power losses and the high-frequency noises are reduced largely. An important difference between the double PWM method and the single PWM method appears a driving zone in which an alternative-current (AC) output voltage of the H-bridge becomes zero. The single PWM method stops the PWM-controlling in this driving zone. Accordingly, high-frequency power losses are not generated.

1. A power system of an electric vehicle comprising a controller (9) for controlling a dual inverter (200) consisting of a first three-phase inverter (30) and a second three-phase inverter (40), which are connected to a double-ended three-phase coil (50) of a three-phase motor,
wherein the power system has a DC power supply (100) for applying a power-supply voltage (Vc) to the dual inverter (200),
wherein a plurality of the output terminals of the first three-phase inverter (40) is connected to a connector (400) for connecting to a single-phase grid and/or a three-phase grid.

2. The power system of the electric vehicle according to claim 1, wherein the second three-phase inverter (30) rectifies and steps up a grid voltage applied from the connector (400) through the double-ended three-phase coil (50) in a voltage-boosting charging mode.

3. The power system of the electric vehicle according to claim 1, wherein the first three-phase inverter (40) rectifies a grid voltage applied through the connector (400) in a voltage-dropping charging mode, wherein the DC power supply (100) has a bi-directional DCDC converter (102) for steps down the rectified grid voltage, and applies the stepped-down voltage to a battery (101) of the DC power supply (100) in the voltage-dropping charging mode.

4. The power system of the electric vehicle according to claim 3, wherein the bi-directional DCDC converter (102) has;
a series transistor (3) for connecting two batteries (1,2) as the battery (101) to series,
two parallel transistors (4, 5) for connecting the two batteries (1,2),
a reactor (7) for accumulating magnetic energy,
an outputting transistor (6) for outputting voltages of the batteries (1, 2), and
a discharging diode (8) for discharging the reactor (7).

5. The power system of the electric vehicle according to claim 4, wherein the controller (9) has;
a parallel mode for connecting the two batteries (1,2) in parallel,
a series mode for connecting the two batteries (1,2) to series,
a voltage-boosting mode for stepping up a voltage sum of the two batteries (1,2), and
a voltage-dropping mode for stepping down the power-supply voltage (Vc) applied from the dual inverter (200).

6. The power system of the electric vehicle according to claim 5, wherein the controller (9) selects one of the parallel mode, the series mode, and the voltage-dropping mode in accordance with a voltage value of the grid voltage.

7. The power system of the electric vehicle according to claim 1, wherein the controller (9) executes an upper-arm-conduction type single PWM method for constantly turning on an upper arm switch of the fixed potential leg, wherein the PWM-leg and the fixed are changed in turn every 180 electrical degrees in a period in which the upper-arm-conduction type single PWM method is executed.

8. The power system of the electric vehicle according to claim 7, wherein the controller (9) executes an upper-arm-conduction type single PWM method in which an upper arm switch of the fixed potential leg is constantly turned on, wherein the PWM-leg and the fixed are changed in turn every 180 electrical degrees in a period in which the upper-arm-conduction type single PWM method is executed.

9. A power system of an electric vehicle comprising a controller (9) for controlling a connection-changing circuit (10) capable to change connection of two batteries (1,2), wherein the connection-changing circuit (10) has;
a series transistor (3) for connecting the two batteries (1,2) to series,
two parallel transistors (4,5) for connecting the two batteries (1,2) in parallel,
a reactor (7) for accumulating magnetic energy,
an outputting transistor (6) for outputting voltages of the two batteries (1,2), and
a discharging diode for discharging the reactor (7),
wherein reactor (7) is disposed between the series transistor (3) and one of the two parallel transistor (4,5),
wherein the discharging diode (8) is connected to a connection point for connecting the reactor (7) and the series transistor (3).

10. The power system of the electric vehicle according to claim 9, wherein the controller (9) has;
a parallel mode for connecting the two batteries (1,2) in parallel,
a series mode for connecting the two batteries (1,2) to series,
a voltage-boosting mode for stepping up a voltage sum of the two batteries (1,2), and
a voltage-dropping mode for stepping down a voltage applied to a DC power supply (100) including the two batteries (1,2) and the connection-changing circuit (10).

11. The power system of the electric vehicle according to claim 9, wherein the controller (9) has a transient mode for gradually changing a power-supply voltage (Vc) as an outputting voltage of the DC power supply (100) during a transient period for changing the parallel mode and the series mode.

12. The power system of the electric vehicle according to claim 10, wherein the parallel mode includes a voltage-equalizing mode for charging only the battery with lower voltage when a voltage difference between the two batteries (1,2) is higher than a predetermined value.

13. The power system of the electric vehicle according to claim 10, wherein the parallel mode includes a voltage-equalizing mode for discharging only the battery with higher voltage when a voltage difference between the two batteries (1,2) is higher than a predetermined value.

14. The power system of the electric vehicle according to claim 9, wherein the controller (9) has a battery trouble mode for turning-off the parallel transistor connected to one bad battery when the two batteries (1,2) includes the one bad battery.

15. The power system of the electric vehicle according to claim 10, wherein the DC power supply (100) includes an sub DCDC converter (300) for controlling a charging current supplied from the two batteries (1,2) to a low-voltage battery (29), wherein the sub DCDC converter (300) has;
a transformer (20) having a first primary coil (21), a second primary coil (22), and at least one secondary coil (23, 24),
a first switch (11) for controlling a primary current supplied from the battery (2) to the first primary coil (21),
a second switch (12) for controlling a primary current supplied from the battery (1) to the second primary coil (22), and
a rectifier (30) for rectifying a secondary voltage of the secondary coil (23, 24) and for charging the low voltage battery (29).

16. A power system of the electric vehicle comprising a controller (9) for controlling a dual inverter (200) consisting of two three-phase inverters (30,40) connected to a double-ended three-phase coil (50) of a three-phase motor, wherein each of three H-bridges of the dual inverter (200) consists of;
a PWM-leg for applying a pulse-width-modulation (PWM) voltage to one of phase coils (5U,5V,5W) of the dual-ended three-phase coil (50), and
a fixed potential leg for applying a DC voltage to the one of the phase coils (5U,5V,5W),
wherein the controller (9) executes a single PWM method for changing the PWM-leg and the fixed potential leg every predetermined period.

17. The power system of the electric vehicle according to claim 16, wherein the controller (9) executes upper-arm-conduction type single PWM method for constantly turning on an upper arm switch of the fixed potential leg, wherein the PWM-leg and the fixed are changed in turn every 180 electrical degrees in a period in which the upper-arm-conduction type single PWM method is executed.

18. The power system of the electric vehicle according to claim 16, wherein a DC power supply (100) supplies each of phase power-supply currents (IUP, IVP, IWP) to each of the phase coils (5U,5V,5W) in each of current-supplying periods (TX) arranged in a common PWM cycle period (TC), wherein the current-supplying periods (TX) are arranged in the common PWM cycle period (TC) so as to avoid overlapping of the current-supplying periods (TX) under a predetermined partial load condition.

19. The power system of the electric vehicle according to claim 18, wherein the current-supplying periods are arranged continuously in the common PWM cycle period (TC).

20. The power system of the electric vehicle according to claim 16, wherein the controller (9) executes a double H-bridge mode in which one of the H-bridges is stopped in turn under a predetermined partial load condition.

21. The power system of the electric vehicle according to claim 16, wherein the controller (9) has a battery-heating mode for supplying a single-phase AC current from a battery (101) to a part of the three-phase coil (50) in order to heat the battery (101) in cold condition.
